(19) United States
(12) Patent Application Publication
(10) Pub. No.: US 2024/0022981 A1
(43) Pub. Date: Jan. 18, 2024

(54) MOBILITY IN SIDELINK-ASSISTED ACCESS LINK CONNECTIVITY

(71) Applicant: QUALCOMM Incorporated, San Diego, CA (US)

(72) Inventors: Peng CHENG, Beijing (CN); Gavin Bernard HORN, La Jolla, CA (US); Karthika PALADUGU, Hyderabad (IN); Hong CHENG, Basking Ridge, NJ (US); Qing LI, Princeton Junction, NJ (US); Ozcan OZTURK, San Diego, CA (US); Soo Bum LEE, San Diego, CA (US)

(21) Appl. No.: 18/036,866

(22) PCT Filed: Jan. 15, 2021
(86) PCT No.: PCT/CN2021/072148

§ 371 Date: May 12, 2023

(51) Int. Cl. H04W 36/00

(52) U.S. Cl. CPC H04W 36/03

(57) ABSTRACT

Apparatus, methods, and computer-readable media for facilitating mobility in sidelink-assisted access link connectivity are disclosed herein. An example method for wireless communication at a user equipment (UE) includes establishing a sidelink connection with a first assistant node (AN) and establishing an access link connection with a first primary node (PN), the first AN and the first PN communicating via a first network interface. The example method also includes determining an occurrence of a node-change triggering event associated with at least one of the first AN and the first PN. The example method also includes performing a node-change procedure based on the occurrence of the node-change triggering event. The example method also includes communicating with at least one of a second AN or a second PN based on the node-change procedure, the second AN and the second PN communicating via a second network interface.

### BACKGROUND

### Technical Field

The present disclosure relates generally to communication systems, and more particularly, to mobility procedures within a wireless communication system.

### Introduction

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication of a user equipment (UE). An example apparatus establishes a sidelink connection with a first assistant node (AN) and establishing an access link connection with a first primary node (PN), the first AN and the first PN communicating via a first network interface. The example apparatus also determines an occurrence of a node-change triggering event associated with at least one of the first AN and the first PN. Additionally, the example apparatus performs a node-change procedure based on the occurrence of the node-change triggering event. The example apparatus also communicates with at least one of a second AN or a second PN based on the node-change procedure, the second AN and the second PN communicating via a second network interface.

In another aspect of the disclosure, a method, a computer-readable medium, and an apparatus are provided for wireless communication of a first primary node. An example apparatus receives a node-change triggering event notification. The example apparatus also performs a node-change procedure based on the node-change triggering event notification.

In another aspect of the disclosure, a method, a computer-readable medium, and an apparatus are provided for wireless communication of a first primary node. An example apparatus receives a node-change triggering event notification. The example apparatus also performs a node-change procedure based on the node-change triggering event notification. Additionally, the example apparatus communicates data with a user equipment (UE) via an access link connection based on communications within a millimeter wave (mmW) frequency range. The example apparatus also communicates control signaling with the UE via a first assistant node (AN), the first PN and the first AN communicating via a first network interface connection.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and UE in an access network.

FIG. 4 illustrates example aspects of a sidelink slot structure.

FIG. 5 is an example diagram illustrating wireless communication between devices based on sidelink-assisted access link connectivity, in accordance with the teachings disclosed herein.

FIG. 6 is another example diagram illustrating wireless communication between devices based on sidelink-assisted access link connectivity, in accordance with the teachings disclosed herein.

FIG. 7 is a diagram illustrating an example system based on sidelink communication and access link communication, in accordance with the teachings disclosed herein.

FIG. 8 is an example communication flow between a UE, a source assistant node (AN), a source primary node (PN), a target AN, and a target PN performing an inter-PN change, in accordance with the teachings disclosed herein.

FIG. 9 is an example communication flow between a UE, a source AN, a source PN, and a target AN performing an inter-AN and intra-PN change, in accordance with the teachings disclosed herein.

FIG. 10 is an example communication flow between a UE, a source AN, a source PN, a target AN, and a target PN performing an inter-AN and inter-PN change, in accordance with the teachings disclosed herein.

FIG. 11 is an example communication flow between a UE, a source AN, a source PN, and a target PN performing a fast primary cell group recovery, in accordance with the teachings disclosed herein.

FIG. 12 is a flowchart of a method of wireless communication at a UE, in accordance with the teachings disclosed herein.

FIG. 13 is another flowchart of a method of wireless communication at a UE, in accordance with the teachings disclosed herein.

FIG. 14 is another flowchart of a method of wireless communication at a UE, in accordance with the teachings disclosed herein.

FIG. 15 is another flowchart of a method of wireless communication at a UE, in accordance with the teachings disclosed herein.

FIG. 16 is a diagram illustrating an example of a hardware implementation for an example apparatus, in accordance with the teachings disclosed herein.

FIG. 17 is a flowchart of a method of wireless communication at a source PN, in accordance with the teachings disclosed herein.

FIG. 18 is a flowchart of a method of wireless communication at a target PN, in accordance with the teachings disclosed herein.

FIG. 19 is a diagram illustrating an example of a hardware implementation for an example apparatus, in accordance with the teachings disclosed herein.

### DETAILED DESCRIPTION

In some examples, a user equipment (UE) may establish a connection with a base station to facilitate communication. For example, the UE may establish an access link connection (sometimes referred to as a “Uu link” or a “cellular link”) with the base station. The base station may be configured to operate in millimeter wave frequencies and/or near millimeter wave frequencies in communication with the UE. Communications within the millimeter wave frequencies may provide high throughput and, thus, may be beneficial for communicating data between the UE and the base station. However, communications within the millimeter wave frequencies may also be susceptible to interruptions in service (e.g., due to blockage).

In some such examples, the UE may also establish a connection with a sidelink device. For example, the UE may establish a sidelink connection (sometimes referred to as a “PC5 link”) with the sidelink device. The sidelink device may be connection with the base station via a network interface. Sidelink communication enables a first UE to communicate with another UE directly. For example, the first UE and a second UE may communicate without routing the communication through a base station. As an example, sidelink may be beneficial for vehicle-based communications that allows a vehicle UE to communicate directly with another UE associated with, for example, another vehicle, a vulnerable road user (e.g., a pedestrian, a person on a bike, etc.), a network node, an infrastructure node, etc. Sidelink and the aspects presented herein are not limited to vehicular applications and may be applied for other types of sidelink devices.

In some examples, the sidelink device may be configured to operate in a sub-6 GHz spectrum. Communications within the sub-6 GHz spectrum may be more robust than communications within the millimeter wave frequencies. By establishing the sidelink connection with the sidelink device, the sidelink device may act as an anchor node for millimeter wave communication over the sidelink connection. For example, the sidelink connection may provide a reliable control-plane to manage the access link connection between the UE and the base station. The sidelink connection may also provide a fallback user-plane to reduce interruptions in service. That is, the UE may communicate control signaling with (e.g., transmit control signaling to and/or receive control signaling from) the base station via the sidelink device, while communicating data with the base station directly via the access link connection. In some such examples, the control signaling may comprise an encapsulated message so that the control signaling is transparent to the sidelink device. For example, the sidelink device may forward control signaling to and/or from the UE while foregoing processing of the control signaling.

In some examples, characteristics of the sidelink connection and/or the access link connection may trigger the UE to perform a mobility procedure in which the UE establishes a new connection with a new sidelink device and/or a new base station. For example, the trigger to cause the UE to perform the mobility procedure may be based on a measurement of the sidelink connection and/or the access link connection. In some examples, the trigger to cause the UE to perform the mobility procedure may be based on a detection of a radio link failure (RLF) associated with the sidelink connection and/or the access link connection.

Aspects disclosed herein provide techniques for enabling the UE to perform the mobility procedure. In some examples, performing the mobility procedure may include performing an inter-PN change in which the UE establishes an access link connection with a new base station. For example, the UE may release the access link connection with the serving (or current) base station and establish a new access link connection with a target (or new) base station. In some examples, the UE may also establish a new sidelink connection with a target sidelink device. It may be appreciated that in some examples, the serving sidelink device and the target sidelink device may comprise a same sidelink device, but aspects of the sidelink connection with the serving sidelink device and the new sidelink connection with the target sidelink device may be different, for example, due to the serving base station and the target base station being different base stations.

In some examples, performing the mobility procedure may include performing an inter-AN change in which the UE establishes a sidelink connection with a new sidelink device. For example, the UE may detect the presence of another sidelink device (e.g., a target sidelink device) that satisfies sidelink connection thresholds when the sidelink connection with the serving sidelink device does not satisfy the sidelink connection thresholds. In some examples, performing the inter-AN change may also cause the UE to determine whether the serving sidelink device and the target sidelink device are in communication with a same base station or a different base station. For example, when the serving sidelink device and the target sidelink device are in communication with the same base station, the UE may transmit a notification to the target sidelink device that the same base station is in communication with the serving sidelink device and the target sidelink device (e.g., a case of an intra-PN and inter-AN change). In some such examples, the notification may trigger the target sidelink device to exchange configuration information with the base station so that the target sidelink device may operate as the assistant node for communications between the base station and the UE.

In examples in which the serving sidelink device and the target sidelink device are in communication with different base stations, the UE may release the access link connection with the serving base station after establishing the sidelink connection with the target sidelink device. The UE may then establish an access link connection with the target base station via the sidelink connection with the target sidelink device.

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example aspects, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

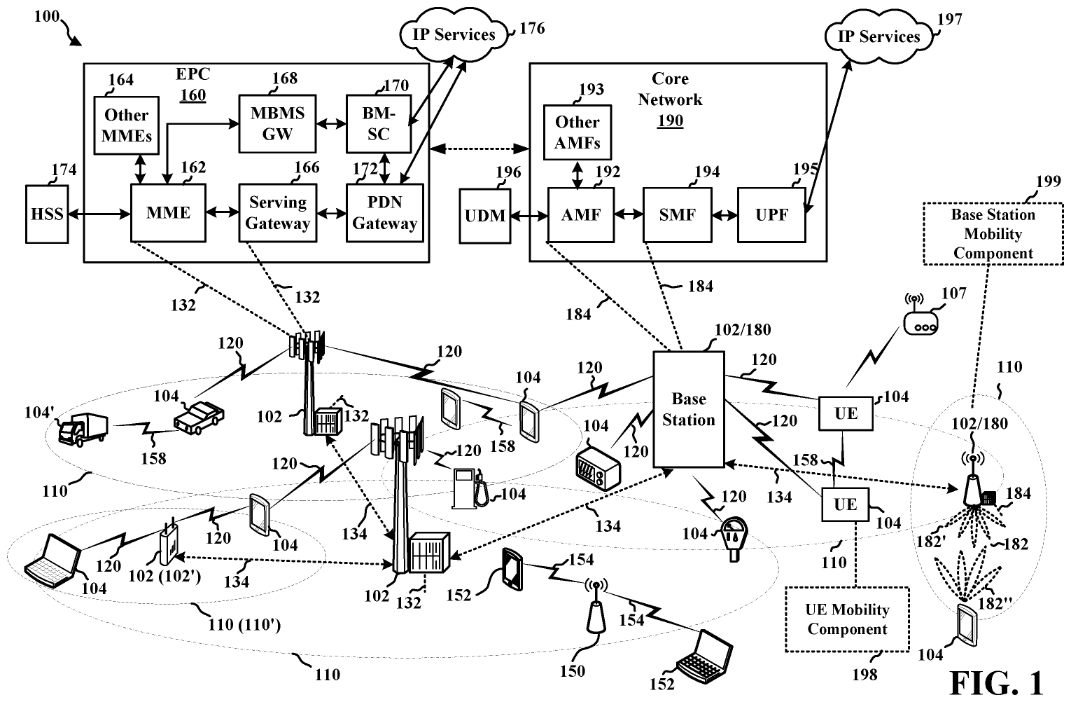

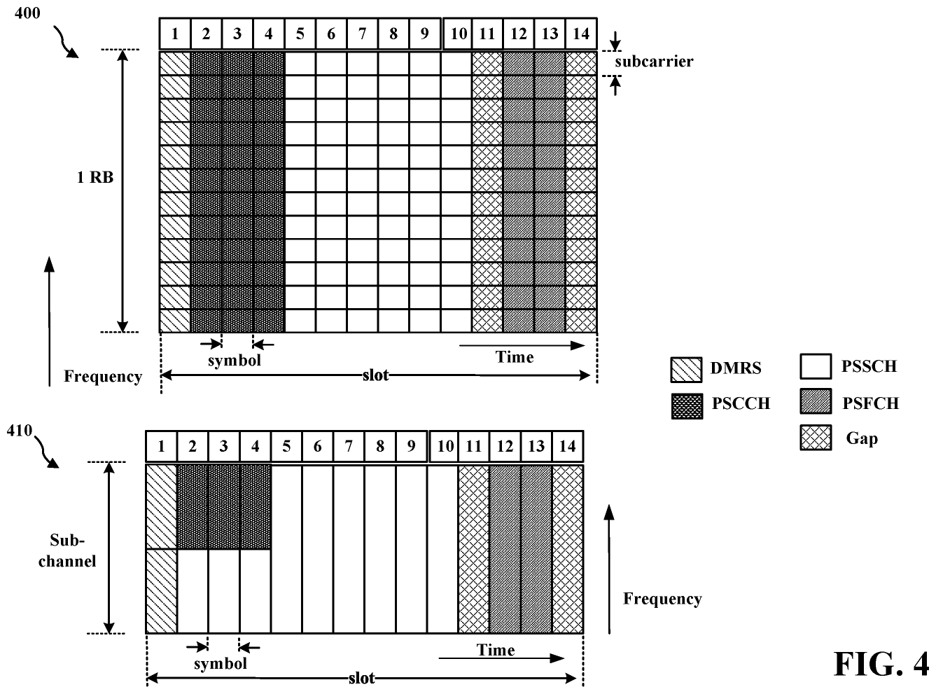

FIG. 1 is a diagram illustrating an example of a wireless communications system and an access network 100 in which base stations 102 or 180 may wirelessly communicate with UEs 104. Some examples of device-to-device (D2D) communications may include vehicle-based communication devices that can communicate from vehicle-to-vehicle (V2V), vehicle-to-infrastructure (V2I) (e.g., from the vehicle-based communication device to road infrastructure nodes such as a Road Side Unit (RSU)), vehicle-to-network (V2N) (e.g., from the vehicle-based communication device to one or more network nodes, such as a base station), vehicle-to-pedestrian (V2P), cellular vehicle-to-everything (C-V2X), and/or a combination thereof and/or with other devices, which can be collectively referred to as vehicle-to-anything (V2X) communications. Sidelink communication may be based on V2X or other D2D communication, such as Proximity Services (ProSe), etc. In addition to UEs, sidelink communication may also be transmitted and received by other transmitting and receiving devices, such as an RSU 107, etc. Sidelink communication may be exchanged using a PC5 interface, such as described in connection with the example in FIG. 4.

In some examples, a UE (e.g., such as the UE 104) may be in communication with a base station (e.g., such as the base station 180) and in communication with a sidelink device (e.g., such as the RSU 107). For example, the sidelink device may operate as an anchor node for communications between the UE and the base station. For example, the UE may communicate data with the base station via the connection between the UE and the base station, and the UE may communicate control signaling with the base station via the connection between the UE and the sidelink device. In such examples, the sidelink device may act as a relay and forward the control signaling to and/or from the UE and the base station.

In some examples, a UE, such as the UE 104, may be configured to manage one or more aspects of wireless communication by performing mobility procedures to switch from a serving device to a target device. As an example, in FIG. 1, the UE 104 may include a UE mobility component 198 configured to establish a sidelink connection with a first assistant node (AN) and establishing an access link connection with a first primary node (PN), the first AN and the first PN communicating via a first network interface. The example UE mobility component 198 may also be configured to determine an occurrence of a node-change triggering event associated with at least one of the first AN and the first PN. The example UE mobility component 198 may also be configured to perform a node-change procedure based on the occurrence of the node-change triggering event. The example UE mobility component 198 may also be configured to communicate with at least one of a second AN or a second PN based on the node-change procedure, the second AN and the second PN communicating via a second network interface.

Still referring to FIG. 1, a base station, such as the base station 102/180, may be configured to manage one or more aspects of wireless communication by facilitating a UE to perform a mobility procedure. As an example, in FIG. 1, the base station 102/180 may include a base station mobility component 199. In some examples, the base station mobility component 199 may be configured to facilitate the UE performing an inter-PN change from the base station 102/180 to a target base station. For example, the base station mobility component 199 may be configured to receive a node-change triggering event notification. The example base station mobility component 199 may also be configured to perform a node-change procedure based on the node-change triggering event notification.

In some examples, the base station mobility component 199 may be configured to facilitate the UE performing an inter-PN change from a serving base station to the base station 102/180. For example, the base station mobility component 199 may be configured to receive a node-change triggering event notification. The example base station mobility component 199 may also be configured to perform a node-change procedure based on the node-change triggering event notification. The example base station mobility component 199 may also be configured to communicate data with a user equipment (UE) via an access link connection based on communications within a millimeter wave (mmW) frequency range. The example base station mobility component 199 may also be configured to communicate control signaling with the UE via a first assistant node (AN), the first PN and the first AN communicating via a first network interface connection.

Although the following description provides examples directed to 5G NR (and, in particular, to mobility in sidelink-assisted 5G NR connectivity), the concepts described herein may be applicable to other similar areas, such as LTE, LTE-A, CDMA, GSM, and/or other wireless technologies, in which wireless communication devices may employ a sidelink device may assist a UE in 5G NR communications with a base station.

The wireless communications system (also referred to as a wireless wide area network (WWAN)) includes the base stations 102, the UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub-6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

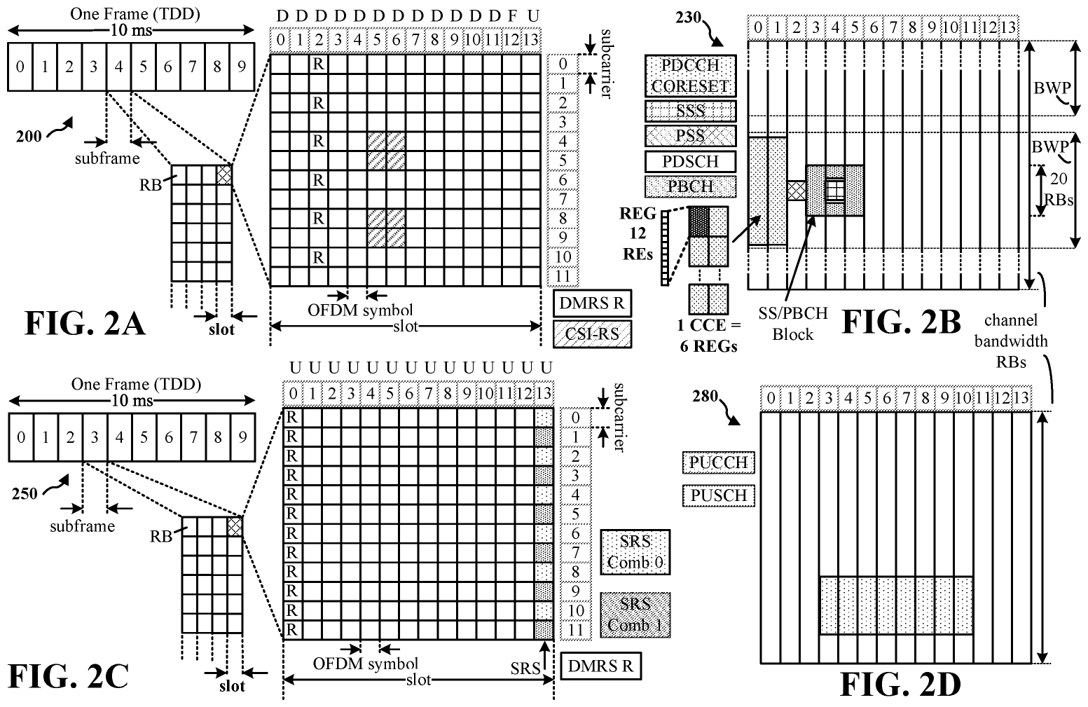

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kHz, where y is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) information (ACK/negative ACK (NACK)) feedback. The PUSCH carries data, and may additionally be used to carry a buffer status report (BSR), a power headroom report (PHR), and/or UCI.

FIG. 4 illustrates example diagrams 400 and 410 illustrating examples slot structures that may be used for wireless communication between UE 104 and UE 104′, e.g., for sidelink communication. The slot structure may be within a 5G/NR frame structure. Although the following description may be focused on 5G NR, the concepts described herein may be applicable to other similar areas, such as LTE, LTE-A, CDMA, GSM, and other wireless technologies. This is merely one example, and other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. Diagram 400 illustrates a single slot transmission, e.g., which may correspond to a 0.5 ms transmission time interval (TTI). Diagram 410 illustrates an example two-slot aggregation, e.g., an aggregation of two 0.5 ms TTIs. Diagram 400 illustrates a single RB, whereas diagram 410 illustrates N RBs. In diagram 410, 10 RBs being used for control is merely one example. The number of RBs may differ.

A resource grid may be used to represent the frame structure. Each time slot may include a resource block (RB) (also referred to as physical RBs (PRBs)) that extends 12 consecutive subcarriers. The resource grid is divided into multiple resource elements (REs). The number of bits carried by each RE depends on the modulation scheme. As illustrated in FIG. 4, some of the REs may include control information, e.g., along with demodulation RS (DMRS). FIG. 4 also illustrates that symbol(s) may include CSI-RS. The symbols in FIG. 4 that are indicated for DMRS or CSI-RS indicate that the symbol includes DMRS or CSI-RS REs. Such symbols may also include REs that include data. For example, if a number of ports for DMRS or CSI-RS is 1 and a comb-2 pattern is used for DMRS/CSI-RS, then half of the REs may include the RS and the other half of the REs may include data. A CSI-RS resource may start at any symbol of a slot, and may occupy 1, 2, or 4 symbols depending on a configured number of ports. CSI-RS can be periodic, semi-persistent, or aperiodic (e.g., based on control information triggering). For time/frequency tracking, CSI-RS may be either periodic or aperiodic. CSI-RS may be transmitted in bursts of two or four symbols that are spread across one or two slots. The control information may include Sidelink Control Information (SCI). At least one symbol may be used for feedback, as described herein. A symbol prior to and/or after the feedback may be used for turnaround between reception of data and transmission of the feedback. Although symbol 12 is illustrated for data, it may instead be a gap symbol to enable turnaround for feedback in symbol 13. Another symbol, e.g., at the end of the slot may be used as a gap. The gap enables a device to switch from operating as a transmitting device to prepare to operate as a receiving device, e.g., in the following slot. Data may be transmitted in the remaining REs, as illustrated. The data may include the data message described herein. The position of any of the SCI, feedback, and LBT symbols may be different than the example illustrated in FIG. 4. Multiple slots may be aggregated together. FIG. 4 also illustrates an example aggregation of two slot. The aggregated number of slots may also be larger than two. When slots are aggregated, the symbols used for feedback and/or a gap symbol may be different that for a single slot. While feedback is not illustrated for the aggregated example, symbol(s) in a multiple slot aggregation may also be allocated for feedback, as illustrated in the one slot example.

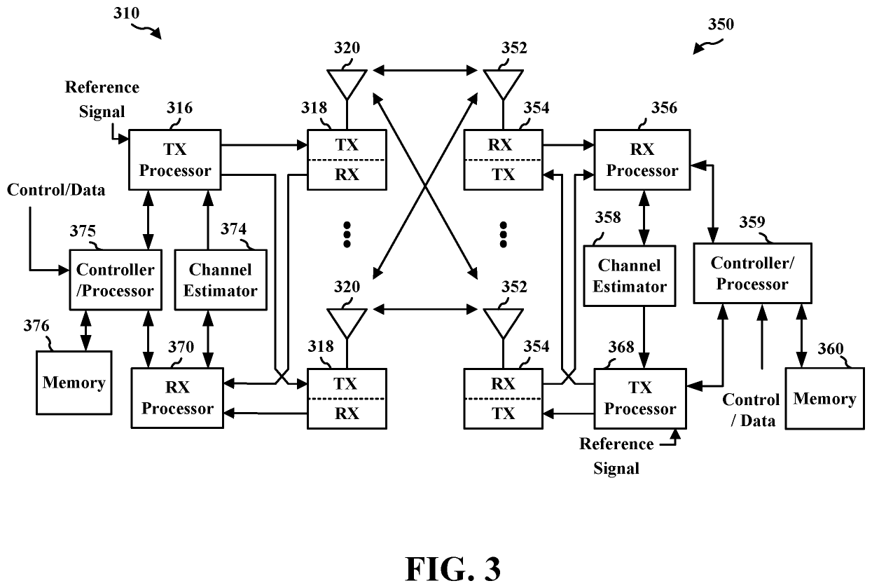

FIG. 3 is a block diagram of a first communication device 310 in communication with a second communication device 350. In some examples, the communication between the communication devices 310, 350 may be based on sidelink. For example, the first communication device may comprise a transmitting device (e.g., the UE 104 of FIG. 1) communicating with one or more target devices using the second communication device 350 (e.g., the RSU 107 of FIG. 1). The first communication device 310 may communicate with the second communication device 350 using sidelink communication. The first communication device 310 and/or the second communication device 350 may comprise a UE, an access point, a base station, a road side unit (RSU), etc.

In some examples, the communication between the communication devices 310, 350 may be in an access network. For example, the first communication device 310 may comprise a base station (e.g., the base station 102 or 180 of FIG. 1) and the second communication device 350 may comprise a UE (e.g., the UE 104 of FIG. 1).

In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor (e.g., a TX processor 316) and the receive (RX) processor (e.g., an RX processor 370) implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the second communication device 350. Each spatial stream may then be provided to a different antenna 320 via a separate transmitter 318 TX. Each transmitter 318 TX may modulate an RF carrier with a respective spatial stream for transmission.

At the second communication device 350, each receiver 354 RX receives a signal through its respective antenna 352. Each receiver 354 RX recovers information modulated onto an RF carrier and provides the information to an RX processor 356. A TX processor 368 and the RX processor 356 implement layer 1 functionality associated with various signal processing functions. The RX processor 356 may perform spatial processing on the information to recover any spatial streams destined for the second communication device 350. If multiple spatial streams are destined for the second communication device 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the first communication device 310. These soft decisions may be based on channel estimates computed by a channel estimator 358. The soft decisions are then decoded and deinterleaved to recover the data and control signals that were originally transmitted by the first communication device 310 on the physical channel. The data and control signals are then provided to a controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the first communication device 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer ofupper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by the channel estimator 358 from a reference signal or feedback transmitted by the first communication device 310 may be used by the TX processor 368 to select the appropriate coding and modulation schemes, and to facilitate spatial processing. The spatial streams generated by the TX processor 368 may be provided to different antenna 352 via separate transmitters 354 TX. Each transmitter 354 TX may modulate an RF carrier with a respective spatial stream for transmission.

The UL transmission is processed at the first communication device 310 in a manner similar to that described in connection with the receiver function at the second communication device 350. Each receiver 318 RX receives a signal through its respective antenna 320. Each receiver 318 RX recovers information modulated onto an RF carrier and provides the information to the RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the second communication device 350. IP packets from the controller/processor 375 may be provided to the EPC 160. The controller/processor 375 is also responsible for error detection using an ACK and/or NACK protocol to support HARQ operations.

In aspects in which the first communication device 310 is in communication with the second communication device 350 based on sidelink, at least one of the TX processor 316 or 368, the RX processor 356 or 370, and the controller/processor 359 or 375 may be configured to perform aspects in connection with the UE mobility component 198 of FIG. 1.

In aspects in which the first communication device 310 comprises a base station, at least one of the TX processor 316, the RX processor 370, and the controller/processor 375 may be configured to perform aspects in connection with the base station mobility component 199 of FIG. 1.

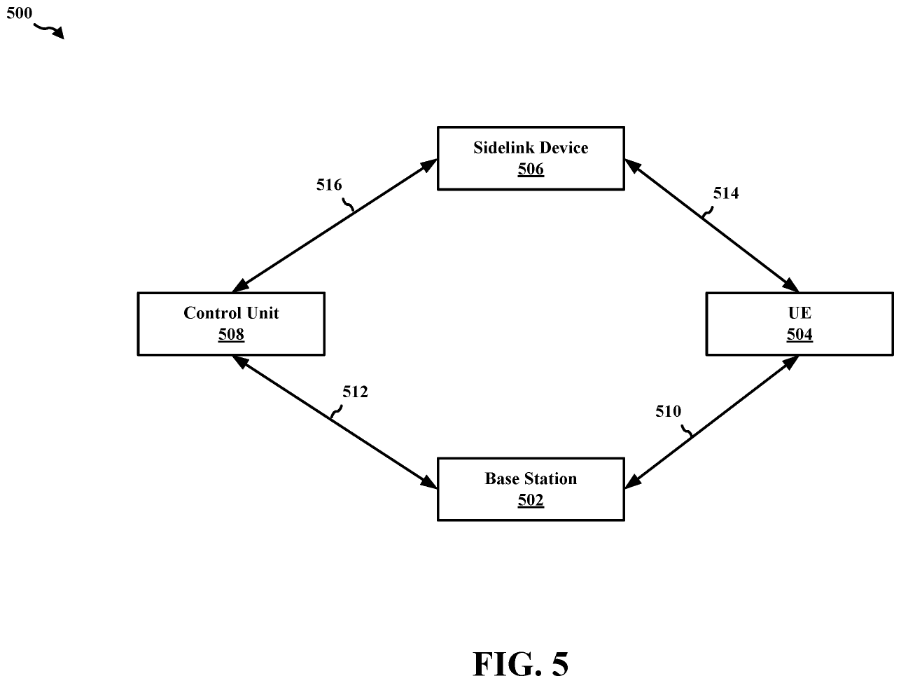

In some examples, a UE may establish a connection with a base station to facilitate communication and may establish a sidelink connection with a sidelink device to operate as an assistant node to facilitate the communication. FIG. 5 is an example diagram illustrating wireless communication 500 between devices based on sidelink-assisted access link connectivity, in accordance with the teachings disclosed herein. The example wireless communication 500 enables non-standalone millimeter wave (“mmW”) communication without a RAT-specific anchor, such as an LTE anchor or a 5G NR anchor.

As shown in FIG. 5, the wireless communication 500 includes a UE 504 in communication with a base station 502 and a sidelink device 506. The base station 502 and the sidelink device 506 are in communication with a control unit 508. Aspects of the base station 502 may be implemented by the base station 102/180 of FIG. 1. Aspects of the UE 504 may be implemented by the UE 104 of FIG. 1. Aspects of the sidelink device 506 may be implemented by a sidelink device, such as the UE 104′ and/or the RSU 107 of FIG. 1. Aspects of the control unit 508 may be implemented by the core network 190 of FIG. 1.

In the illustrated example of FIG. 5, the base station 502 is configured to operate in mmW frequencies and/or near-mmW frequencies. The UE 504 may establish an access link connection 510 (sometimes referred to as a “Uu link”) with the base station 502. The base station 502 may be in communication with the control unit 508 via a first network interface 512. Communications within the mmW frequencies may provide high throughput and, thus, may be beneficial for communicating data between the UE 504 and the base station 502. However, communications within the mmW frequencies may also be susceptible to interruptions in service (e.g., due to blockage).

In some examples, to reduce interruptions in service, the UE 504 may also establish a connection with the sidelink device 506. For example, the UE 504 may establish a sidelink connection 514 (sometimes referred to as a “PC5 link”) with the sidelink device 506. The sidelink device 506 may be in communication with the control unit 508 via a second network interface 516.

Sidelink communication enables the UE 504 to communicate with another UE directly. For example, the UE 504 and the sidelink device 506 may communicate without routing the communication through the base station 502. As an example, sidelink may be beneficial for vehicle-based communications that allows a vehicle UE to communicate directly with another UE associated with, for example, another vehicle, a vulnerable road user (e.g., a pedestrian, a person on a bike, etc.), a network node, an infrastructure node, etc. Sidelink and the aspects presented herein are not limited to vehicular applications and may be applied for other types of sidelink devices.

In the illustrated example, the sidelink device 506 is configured to operate in sub-6 GHz frequencies. Communications within the sub-6 GHz spectrum may be more robust than communications within the mmW frequencies. By establishing the sidelink connection 514 with the sidelink device 506, the sidelink device 506 may act as an anchor node for the UE 504 for mmW communication over the sidelink connection 514. For example, the sidelink connection 514 may provide a reliable control-plane to manage the access link connection 510 between the UE 504 and the base station 502. The sidelink connection 514 may also provide a fallback user-plane to reduce interruptions in service. That is, the UE 504 may communicate control signaling with (e.g., transmit control signaling to and/or receive control signaling from) the base station 502 via the sidelink device 506, while communicating data with the base station 502 directly via the access link connection 510. In some such examples, the control signaling may comprise an encapsulated message so that the control signaling is transparent to the sidelink device 506. For example, the sidelink device 506 may forward control signaling to and/or from the sidelink device 506 while foregoing processing of the control signaling.

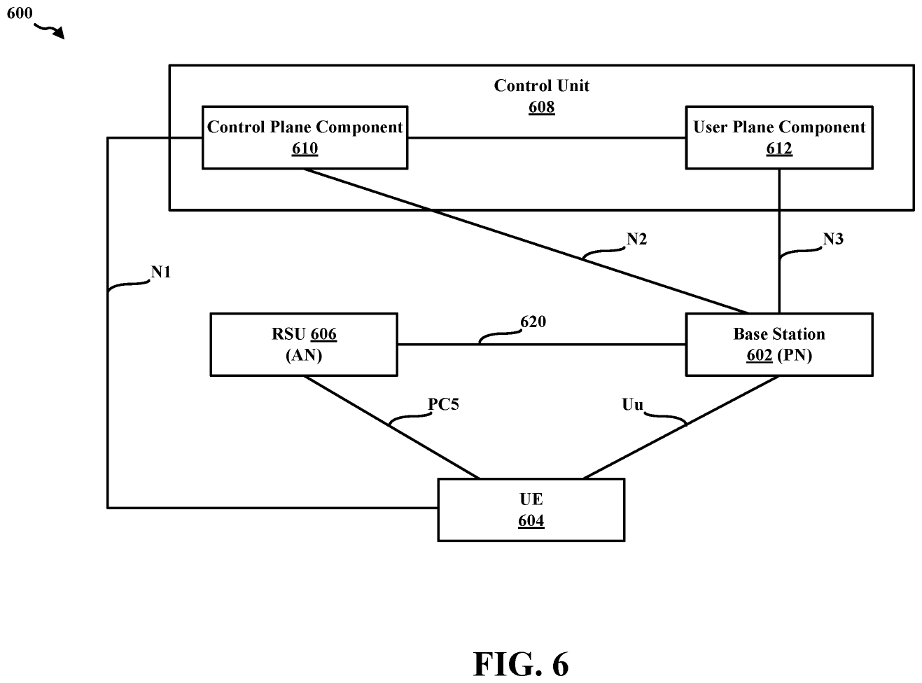

FIG. 6 is another example diagram illustrating wireless communication 600 between devices based on sidelink-assisted access link connectivity, in accordance with the teachings disclosed herein. In the illustrated example, the wireless communication 600 includes a UE 604, a base station 602, an RSU 606, and a control unit 608. The example control unit 608 includes a control plane component 610 in communication with a user plane component 612. The control plane component 610 may be configured to perform control plane functions. The user plane component 612 may be configured to perform user plane functions, such as routing and forwarding of user plane packets. Aspects of the base station 602 may be implemented by the base station 102/180 of FIG. 1 and/or the base station 602 of FIG. 5. Aspects of the ULE 604 may be implemented by the UE 104 of FIG. 1 and/or the UE 504 of FIG. 5. Aspects of the RSU 606 may be implemented by a sidelink device, such as the UE 104′ and/or the RSU 107 of FIG. 1, and/or the sidelink device 506 of FIG. 5. Aspects of the control unit 608 may be implemented by the core network 190 of FIG. 1 and/or the control unit 508 of FIG. 5.

As shown in FIG. 6, the UE 604 is in communication with the base station 602 and a sidelink device (e.g., the RSU 606). The UE 604 may be in communication with the base station 602 via a Uu link that facilitates communications in the mmW (or near-mmW) frequencies. The UE 604 may be in communication with the RSU 606 via a PC5 link that facilitates sub-6 GHz frequencies.

The RSU 606 is in communication with the base station 602 via a network interface 620. In some examples, the network interface 620 may be implemented by an IP tunnel, such as an Xn (or Xn-like) interface, or any other network interface with IP. In some examples, the network interface 620 may be implemented by a co-located interface.

The base station 602 may be in communication with the control unit 608 via an N2 interface and an N3 interface. For example, the base station 602 may communicate control plane packets with the control plane component 610 via the N2 interface. The base station 602 may communication user plane packets with the user plane component 612 via the N3 interface. In some examples, the control unit 608 may be in communication with the UE 604. For example, the control plane component 610 of the control unit 608 may be in communication with the UE 604 via an N1 interface.

In the illustrated example, the RSU 606 is configured to operate as an assistant node (AN) and the base station 602 is configured to operate as a primary node (PN) with respect to the UE 604. In some such examples, the UE 604 may transmit control signaling to the base station 602 and/or receive control signaling from the base station 602 via the RSU 606. The UE 604 may transmit data to the base station 602 and/or receive data from the base station 602 via the Uu link. In some examples, the UE 604 may transmit data to the base station 602 and/or receive data from the base station 602 via the RSU 606. For example, the RSU 606 may operate as a fallback for data.

In the illustrated example, communication of the control signaling may be transparent to the RSU 606. For example, the control signaling may be encapsulated in a message and the RSU 606 may not be able to determine what information is encapsulated.

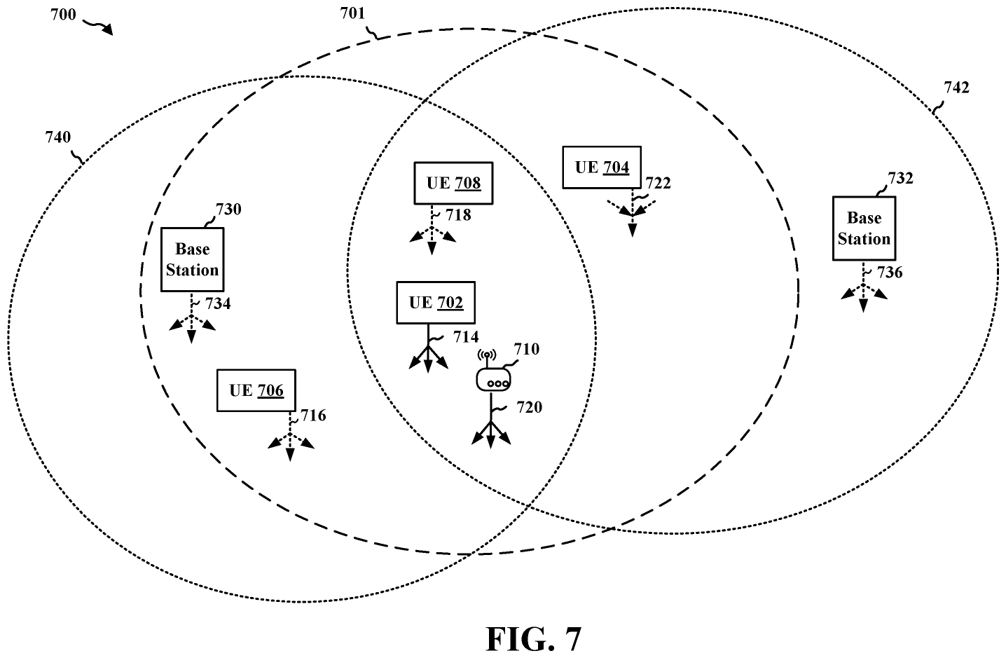

FIG. 7 is a diagram illustrating an example system 700 based on sidelink communication and access link communication, in accordance with the teachings disclosed herein. The sidelink communication may be based on a slot structure comprising aspects described in connection with FIG. 4. For example, a first UE 702 may transmit a transmission 714, e.g., comprising a control channel (e.g., a PSCCH) and/or a corresponding data channel (e.g., a PSSCH), that may be received by a second UE 704, a third UE 706, a fourth UE 708, and/or an RSU 710 directly from the first UE 702, e.g., without being transmitted through a base station. The UEs 702, 704, 706, 708 and the RSU 710 may each be capable of operating as a transmitting device in addition to operating as a receiving device. Thus, the second UE 704 is illustrated as transmitting a transmission 722, the third UE 706 is illustrated as transmitting a transmission 716, the fourth UE 708 is illustrated as transmitting a transmission 718, and the RSU 710 is illustrated as transmitting a transmission 720. The transmissions 714, 716, 718, 720, 722 may be broadcast or multicast to nearby devices. For example, the first UE 702 may transmit communication intended for receipt by other UEs within a range 701 of the first UE 702.

The first UE 702 may provide sidelink control information (SCI) with information for decoding the corresponding data channel. The SCI may also include information that a receiving device may use to avoid interference. For example, the SCI may indicate time and frequency resources that will be occupied by the data transmission, and may be indicated in a control message from the transmitting device.

In some examples, a base station may communicate with one or more communication devices within a range of the base station. For example, the example of FIG. 7 includes a first base station 730 that may communicate 734 with communication devices within a range 740 of the first base station 730, such as the first UE 702, the third UE 706, the fourth UE 708, and/or the RSU 710. The example of FIG. 7 also includes a second base station 732 that may communicate 736 with communication devices within a range 742 of the second base station 732, such as the first UE 702, the second UE 704, the fourth UE 708, and/or the RSU 710.

In examples disclosed herein, a UE may establish a sidelink connection with a sidelink device and an access link connection with a base station, for example, as described in connection with FIGS. 5 and/or 6. For example, the first UE 702 may establish a sidelink connection with the RSU 710 (e.g., the example PC5 link of FIG. 6) and an access link connection with the first base station 730 (e.g., the example Uu link of FIG. 6). In some such examples, the first UE 702 and the first base station 730 may communicate data directly via the access link connection between the first UE 702 and the first base station 730. The first UE 702 and the first base station 730 may communicate control signaling via the RSU 710. For example, the first UE 702 may transmit control signaling to the RSU 710 via the sidelink connection, and the RSU 710 may forward the control signaling to the first base station 730 via a network interface between the RSU 710 and the first base station 730 (e.g., the example network interface 620 of FIG. 6). As used herein, when the UE establishes a connection with a device, the device may be referred to as a “serving” device or a “source” device. For example, the first base station 730 may be referred to as a serving base station or a source base station, and the RSU 710 be referred to as a serving RSU or a source RSU.

In some aspects, characteristics of the sidelink connection and/or the access link connection may trigger the UE to perform a mobility procedure in which the UE establishes a new connection with a new sidelink device and/or a new base station. For example, the trigger to cause the UE to perform the mobility procedure may be based on a measurement of the sidelink connection and/or the access link connection. In some examples, the trigger to cause the UE to perform the mobility procedure may be based on a detection of a radio link failure (RLF) associated with the sidelink connection and/or the access link connection.

Aspects disclosed herein provide techniques for enabling the UE to perform the mobility procedure. In some examples, performing the mobility procedure may include performing an inter-PN change in which the UE establishes an access link connection with a new base station. For example, the first UE 702 may release the access link connection with the first base station 730 and establish a new access link connection with a target (or new) base station (e.g., the second base station 732). In some examples, the first UE 702 may determine to perform the inter-PN change based on a radio resource management (RRM) measurement associated with the access link connection between the first base station 730 and the first UE 702. For example, the first UE 702 may determine that an RRM measurement (e.g., reference signal received power (RSRP), reference signal received quality (RSRQ), etc.) associated with the access link connection fails to satisfy a threshold. The first UE 702 may perform the inter-PN change from the first base station 730 to a target base station (e.g., the second base station 732) via a handover procedure.

In some examples, the first UE 702 may also establish a new sidelink connection with a target sidelink device when performing the inter-PN change. It may be appreciated that in some examples, the serving sidelink device and the target sidelink device may comprise a same sidelink device, but aspects of the sidelink connection with the serving sidelink device and the new sidelink connection with the target sidelink device may be different, for example, due to the serving base station and the target base station being different base stations.

In some examples, performing the mobility procedure may include performing an inter-AN change in which the UE establishes a sidelink connection with a new sidelink device. For example, the first UE 702 may detect the presence of a set of sidelink devices (e.g., such as the second UE 704, the third UE 706, and/or the fourth UE 708) that satisfies sidelink connection thresholds when the sidelink connection with the serving sidelink device (e.g., the RSU 710) does not satisfy the sidelink connection thresholds. The first UE 702 may select a target sidelink device from the set of sidelink devices and establish a new sidelink connection with the target sidelink device. In some examples, the sidelink connection thresholds may be preconfigured. In some examples, the first UE 702 may receive the sidelink connection thresholds from a base station, for example, via a system information block (SIB) or via RRC signaling.

In some examples, performing the inter-AN change may also cause the UE to determine whether the serving sidelink device and the target sidelink device are in communication with a same base station or a different base station. For example, when the serving sidelink device and the target sidelink device are in communication with the same base station, the UE may transmit a notification to the target sidelink device that the same base station is in communication with the serving sidelink device and the target sidelink device (e.g., a case of an intra-PN and inter-AN change). In some such examples, the notification may trigger the target sidelink device to exchange configuration information with the base station so that the target sidelink device may operate as the assistant node for communications between the base station and the UE.

For example, the first UE 702 may determine to perform an inter-AN change by performing a UE-controlled RSU (re)selection procedure and switch from the RSU 710 to the third UE 706. The first UE 702 may establish a sidelink connection with the third UE 706. The first UE 702 may also determine that the RSU 710 and the third UE 706 are associated with the same base station (e.g., the first base station 730). In some such examples, the first UE 702 may transmit a notification to the third UE 706 that the inter-AN change from the RSU 710 to the third UE 706 satisfies an intra-PN and inter-AN change. The third UE 706 may then notify the first base station 730 of the inter-AN change, which may cause the first base station 730 to reconfigure the third UE 706 to operate as an assistant node for the first UE 702 and the first base station 730.

In examples in which the serving sidelink device and the target sidelink device are in communication with different base stations, the UE may release the access link connection with the serving base station after establishing the sidelink connection with the target sidelink device. The UE may then establish an access link connection with the target base station via the sidelink connection with the target sidelink device.

For example, the first UE 702 may determine to perform an inter-AN change by performing a UE-controlled RSU (re)selection procedure and switch from the third UE 706 to the second UE 704. The first UE 702 may establish a sidelink connection with the second UE 704. The first UE 702 may also determine that the third UE 706 and the second UE 704 are associated with different base stations. For example, the third UE 706 is in communication with the first base station 730 and the second UE 704 is in communication with the second base station 732. In some such examples, after establishing the new sidelink connection with the second base station 732, the first UE 702 may release the access link connection with the first base station 730 and transmit an access link connection request with the second base station 732 via the second UE 704. For example, the first UE 702 may transmit an RRC re-establishment request to the second UE 704 via the new sidelink connection, and the second UE 704 may forward (or relay) the RRC re-establishment request to the second base station 732. In some examples, the second UE 704 and the second base station 732 may exchange messages to configure the second UE 704 to operate as an assistant node for the first UE 702 and the second base station 732. The second base station 732 may also exchange messages with the first base station 730 to obtain UE context information associated with the first UE 702. Obtaining the UE context information from the first base station 730 may facilitate reducing UE signaling overhead by foregoing requesting the first UE 702 to provide the UE context information. The second base station 732 and the first UE 702 may then establish an access link connection by exchanging RRC re-establishment messages via the second UE 704.

In some examples, when performing the inter-AN change, the UE may determine whether the serving sidelink device and the target sidelink device are associated with the same base station or different base stations based on discovery messages broadcast by the sidelink devices. The discovery messages may include a PN identifier for the base station with which the sidelink device is in communication. For example, the third UE 706 may broadcast discovery messages that include a PN identifier corresponding to the first base station 730. The second UE 704 may broadcast discovery messages that include a PN identifier corresponding to the second base station 732. The fourth UE 708 and the RSU 710 may broadcast discovery messages that include a first PN identifier corresponding to the first base station 730 and a second PN identifier corresponding to the second base station 732.

In some examples, the UE may determine to perform a mobility procedure based on an RLF detected in association with the sidelink connection and/or the access link connection. For example, the UE may detect an RLF in associated with the Uu link between the UE and the base station (e.g., a primary cell group (PCG) failure). It may be appreciated that aspects of a primary cell group may be similar to a master cell group (MCG). In some examples in which the UE detects an RLF associated with the Uu link, the UE may attempt to perform a fast PCG recovery. For example, the UE may forego initializing an RRC re-establishment procedure based on the detected Uu link RLF. In some such examples, the UE may transmit a PCG failure indication to the serving base station via the serving sidelink device and corresponding PC5 connection. The PCG failure indication may include one or more of access link measurements associated with available base stations and identifiers associated with the corresponding base stations, sidelink measurements associated with available sidelink devices and identifiers associated with the corresponding sidelink devices and their respective base stations (e.g., PN identifiers), and failure cause information. Examples of access link measurements include RRM measurements such as RSRP, RSRQ, etc. Examples of identifiers associated with the corresponding base stations include a physical cell identifier (PCI) or a cell global identity (CGI). Examples of sidelink measurements include RSRP of the discovery messages and/or sidelink synchronization signals (SLSS) broadcast by the sidelink devices. Examples of failure caused by information include RLF, handover failure, IP check failure, and RRC reconfiguration failure.

Based on the PCG failure indication, the serving base station may determine to perform a handover procedure with a target base station. For example, the serving base station may transmit a handover request to a target base station. The target base station may then exchange messaging with the serving sidelink device to configure the serving sidelink device to operate as assistant node for the UE and the target base station. Based on a handover acknowledgement message from the target base station, the serving base station may transmit a target node configuration message to the UE to enable the UE to establish an access link connection with the target base station.

In some examples, after the UE transmits the PCG failure indication to the serving base station via the source sidelink device, the UE may initiate a timer. If the UE does not receive the target node configuration message from the serving base station before the timer expires, the UE may initiate an RRC re-establishment procedure to establish an access link connection with a base station.

In some examples, the UE may detect an RLF associated with the PC5 link between the UE and the sidelink device (e.g., an assistant cell group (ACG) failure). It may be appreciated that aspects of an assistant cell group may be similar to a secondary cell group (SCG). In examples, in which the UE detects the RLF associated with the PC5 link between the UE and the sidelink device, the UE may perform an inter-AN change.

In some examples, if the UE detects an RLF associated with the Uu link between the base station and the UE and an RLF associated with the PC5 link between the UE and the sidelink device, the UE may forego performing a fast PCG recovery and initiate the RRC re-establishment procedure.

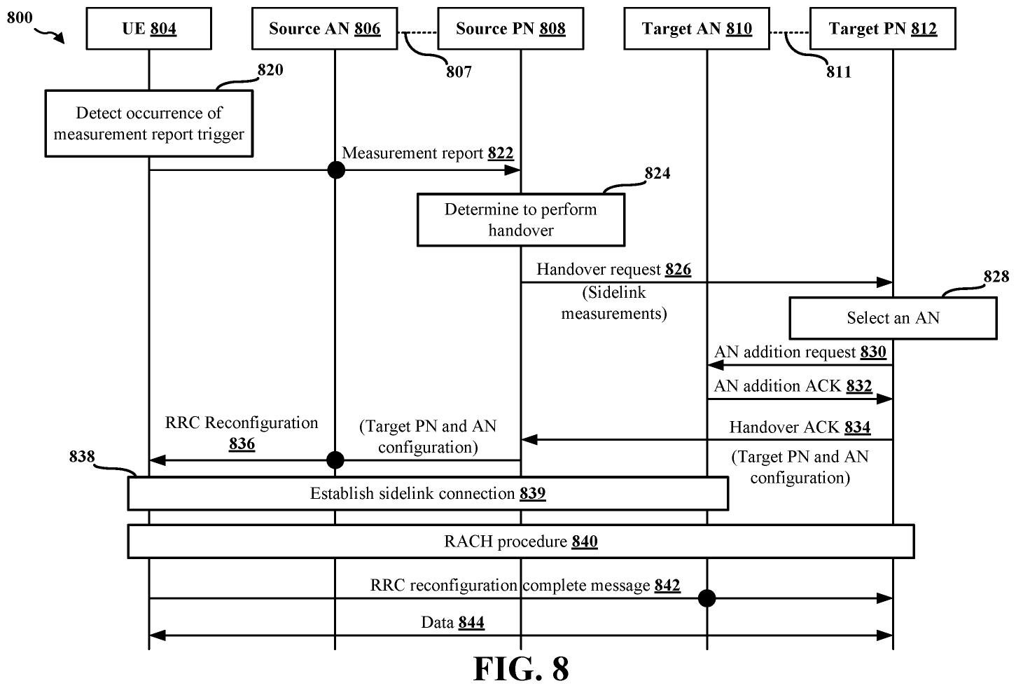

FIG. 8 illustrates an example communication flow 800 between a UE 804, a source AN 806, a source PN 808, a target AN 810, and a target PN 812, as presented herein. In the illustrated example, the source AN 806 and the source PN 808 are in communication (e.g., via a first network interface 807) and the target AN 810 and the target PN 810 are in communication (e.g., via a second network interface 811). In the illustrated example, the UE 804 and the source AN 806 are in communication via a sidelink connection, such as the sidelink connection 514 of FIG. 5 and/or the PC5 link of FIG. 6. The example UE 804 and the source PN 808 are in communication via an access link connection, such as the access link connection 510 of FIG. 4 and/or the Uu link of FIG. 6.

Aspects of the UE 804 may be implemented by the UE 104 of FIG. 1, the UE 504 of FIG. 5, the UE 604 of FIG. 6, and/or the first UE 702 of FIG. 7. Aspects of the source AN 806 and the target AN 810 may be implemented by a sidelink device, such as the example RSU 107 of FIG. 1, the sidelink device 506 of FIG. 5, the RSU 606 of FIG. 6, and/or the UEs 704, 706, 708 and/or the RSU 710 of FIG. 7. Aspects of the source PN 808 and the target PN 812 may be implemented by a base station, such as the base station 102/180 of FIG. 1, the base station 502 of FIG. 5, the base station 602 of FIG. 6, and/or the first base station 730 and/or the second base station 732 of FIG. 7. Aspects of the network interfaces 807, 811 may be implemented by the network interface 620 of FIG. 6.

In the illustrated example, the communication flow 800 facilitate the UE 804 performing an inter-PN change. For example, and with respect to the example of FIG. 7, the communication flow 800 may facilitate the first UE 702 performing a mobility procedure to switch from communicating with the first base station 730 to the second base station 732.

In the illustrated example of FIG. 8, at 820, the UE 804 detects an occurrence of a measurement report trigger. The UE 804 may detect the occurrence of the measurement report trigger based on a measurement associated with the access link connection between the UE 804 and the source PN 808. For example, the UE 804 may perform RRM measurements of the access link connection with the source PN 808 and determine that the RRM measurement (e.g., an RSRP, an RSRQ, etc.) does not satisfy a threshold (e.g., the RRM measurement is worse than the threshold). In some examples, the thresholds may be preconfigured. In some examples, the UE 804 may receive the thresholds from a base station (e.g., the source PN 808) via, for example, a SIB or via RRC signaling.

In some examples, the UE 804 may be configured with a measurement gap in associated with performing the measurements associated with detecting the occurrence of the measurement report trigger. For example, the source PN 808 may configure the UE 804 with a pre-UE gap or a per-frequency range gap. The source PN 808 may configure the UE 804 with the measurement gap via the sidelink connection between the UE 804 and the source AN 806. The pre-UE gap may configure the UE 804 to apply the same gap pattern when performing measurements with respect to the access link connection between the UE 804 and the source PN 808 and when performing measurements with respect to the sidelink connection between the UE 804 and the source AN 806. The pre-frequency range gap may configure the UE 804 to apply a first gap pattern when performing measurements with respect to the access link connection between the UE 804 and the source PN 808 and to apply a second gap pattern when performing measurements with respect to the sidelink connection between the UE 804 and the source AN 806.

The UE 804 transmits a measurement report 822 to the source PN 808. As shown in FIG. 8, the UE 804 transmits the measurement report 822 to the source PN 808 via the source AN 806. For example, the UE 804 may transmit the measurement report 822 to the source AN 806 via the sidelink connection between the UE 804 and the source AN 806, and the source AN 806 may forward the measurement report 822 to the source PN 808 via the first network interface 807.

The measurement report 822 may include available access link measurements and the corresponding cell identifiers. Examples of access link measurements include RRM measurements associated with the source PN 808 and any additional available base stations (e.g., the target PN 812). Examples of cell identifiers include a PCI and a CGI. The measurement report 822 may additionally or alternatively include any available sidelink measurements for serving and neighboring sidelink devices, identifiers associated with the respective serving and neighboring sidelink devices, and PN identifiers for the primary node(s) associated with each of the respective serving and neighboring sidelink devices. Examples of sidelink measurements include RSRP measurements based on discovery messages (e.g., a sidelink discovery—RSRP (SD-RSRP) measurement) or RSRP measurements based on SLSS received from the serving and neighboring sidelink devices, such as the source AN 806 and the target AN 810. Examples of PN identifiers includes a cell identifier, a PCI and frequency, or a CGI.

At 824, the source PN 808 determines to perform a handover. For example, the source PN 808 may determine that one or more of the measurements included in the measurement report 822 qualifies for performing an inter-PN change from the source PN 808 to a new PN (e.g., the target PN 812).

The source PN 808 transmits a handover request 826 that is received by the target PN 812. As shown in FIG. 8, the handover request 826 may include sidelink measurements. For example, the handover request 826 may include the sidelink measurements for the serving and neighboring sidelink devices included in the measurement report 822.

At 828, the target PN 812 selects a sidelink device to operate as an assistant node for the UE 804 and the target PN 812. For example, the target PN 812 may select the sidelink device based on the sidelink measurements included in the handover request 826. As shown in FIG. 8, the target PN 812 selects, at 828, the target AN 810 to operate as the assistant node for the UE 804 and the target PN 812. For example, the target PN 812 transmits an AN addition request 830 that is received by the target AN 810. The target PN 812 may transmit the AN addition request 830 via the second network interface 811. The AN addition request 830 may include information associated with the UE 804 to configure the target AN 810 to operate as the assistant node for the UE 804 and the target PN 812. The target AN 810 transmits an AN addition acknowledgment (ACK) 832 that is received by the target PN 812. The target AN 810 may transmit the AN addition ACK 832 via the second network interface 811. The AN addition ACK 832 may indicate that the target AN 810 is configured to operate as the assistant node for the UE 804 and the target PN 812.

In the illustrated example, the target PN 812 transmits a handover ACK message 834 that is received by the source PN 808. The handover ACK message 834 includes configuration information for the target PN 812 and the target AN 810. For example, the configuration information may enable the UE 804 to establish a sidelink connection with the target AN 810 and to establish an access link connection with the target PN 812.

The source PN 808 transmits an RRC reconfiguration message 836 that is received by the UE 804. In the illustrated example, the source PN 808 transmits the RRC reconfiguration message 836 to the UE 804 via the source AN 806. For example, the source PN 808 may transmit the RRC reconfiguration message 836 to the source AN 806 via the first network interface 807, and the source AN 806 may forward the RRC reconfiguration message 836 to the UE 804 via the sidelink connection between the UE 804 and the source AN 806. In the illustrated example, the RRC reconfiguration message 836 includes the configuration information for the target PN 812 and the target AN 810 that the source PN 808 received from the target PN 812 via the handover ACK message 834. The configuration information may enable the UE 804 to establish a sidelink connection with the target AN 810 and to establish an access link connection with the target PN 812.

At 838, the UE 804 establishes a sidelink connection 839 with the target AN 810. The sidelink connection 839 may comprise a PC5 unicast link, such as a PC5-RRC link or a PC5-S link. The UE 804 may use the configuration information for the target AN 810 included in the RRC reconfiguration message 836 to establish the sidelink connection 839.

The UE 804 performs a random access channel (RACH) procedure 840 to establish an access link connection with the target PN 812. The UE 804 may use the configuration information for the target PN 812 included in the RRC reconfiguration message 836 to establish the access link connection.

The UE 804 transmits an RRC reconfiguration complete message 842 that is received by the target PN 812. In the illustrated example, the UE 804 transmits the RRC reconfiguration complete message 842 to the target PN 812 via the target AN 810. For example, the UE 804 may transmit the RRC reconfiguration complete message 842 to the target AN 810 via the sidelink connection 839, and the target AN 810 may forward the RRC reconfiguration complete message 842 to the target PN 810 via the second network interface 811.

The UE 804 and the target PN 812 may then proceed to transmit data via the access link connection between the UE 804 and the target PN 812.

In the illustrated example, the target PN 812 selects the target AN 810 to operate as the assistant node between the UE 804 and the target PN 812. As shown in FIG. 8, the target AN 810 and the source AN 806 are different assistant nodes. In other examples, the target PN 812 may select the same sidelink device to operate as the assistant node as the source AN 806. For example, the target PN 812 may select the source AN 806 to operate as the assistant node based on the sidelink measurements included in the handover request 826. In some such examples, the UE 804 may forego establishing the sidelink connection 839 since the UE 804 is already in connection with the selected sidelink device (e.g., the source AN 806).

In the illustrated example, the UE 804 transmits the RRC reconfiguration complete message 842 to the target PN 812, via the target AN 810, after performing the RACH procedure 840. However, it may be appreciated that the UE 804 may transmit the RRC reconfiguration complete message 842 to the target PN 812 before performing the RACH procedure or as part of performing the RACH procedure.

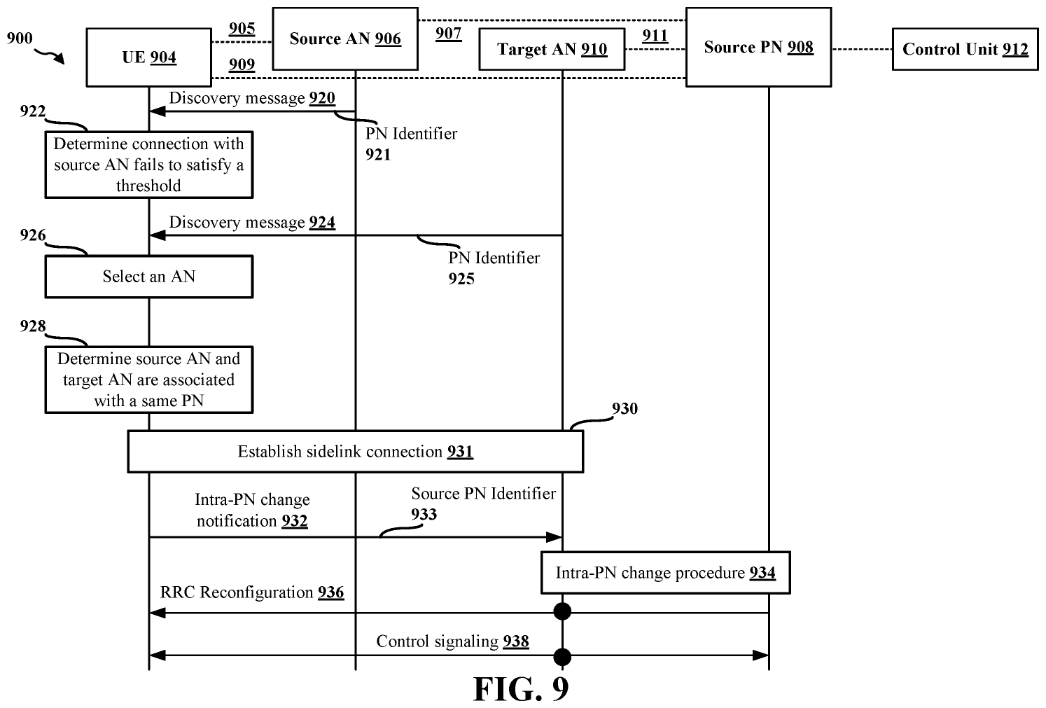

FIG. 9 illustrates an example communication flow 900 between a UE 904, a source AN 906, a source PN 908, and a target AN 910, as presented herein. In the illustrated example, the source AN 906 and the source PN 908 are in communication (e.g., via a first network interface 907) and the target AN 910 and the source PN 908 are in communication (e.g., via a second network interface 911). The source PN 908 may be in communication with a control unit 912, such as the example control unit 508 of FIG. 5 and/or the control unit 608 of FIG. 6. In the illustrated example, the UE 904 and the source AN 906 are in communication via a sidelink connection 905. The example UE 904 and the source PN 908 are in communication via an access link connection 909.

Aspects of the UE 904 may be implemented by the UE 104 of FIG. 1, the UE 504 of FIG. 5, the UE 604 of FIG. 6, and/or the first UE 702 of FIG. 7. Aspects of the source AN 906 and the target AN 910 may be implemented by a sidelink device, such as the example RSU 107 of FIG. 1, the sidelink device 506 of FIG. 5, the RSU 606 of FIG. 6, and/or the UEs 704, 706, 708 and/or the RSU 710 of FIG. 7. Aspects of the source PN 908 may be implemented by a base station, such as the base station 102/180 of FIG. 1, the base station 502 of FIG. 5, the base station 602 of FIG. 6, and/or the first base station 730 and/or the second base station 732 of FIG. 7. Aspects of the sidelink connection 905 may be implemented by the sidelink connection 514 of FIG. 5 and/or the PC5 link of FIG. 6. Aspects of the access link connection 909 may be implemented by the access link connection 510 of FIG. 5 and/or the Uu link of FIG. 6. Aspects of the network interfaces 907, 911 may be implemented by the network interface 620 of FIG. 6.

In the illustrated example, the communication flow 1000 facilitates the UE 1004 performing an intra-PN and inter-AN change. For example, and with respect to the example of FIG. 7, the first UE 702 may be in communication with the RSU 710 via a sidelink connection and may be in communication with the first base station 730 via an access link connection. The communication flow 1000 may facilitate the first UE 702 performing a mobility procedure to switch from communicating with the RSU 710 to the third UE 706, and where the RSU 710 and the third UE 706 are each in communication with the first base station 730.

The source AN 906 transmits a discovery message 920 that is received by the UE 904 via the sidelink connection 905. The source AN 906 may broadcast the discovery message 920 periodically, aperiodically, and/or as a one-time event. The discovery message 920 may enable the UE 904 to perform a sidelink measurement (e.g., to measure an RSRP) of the sidelink connection 905. In some examples, the discovery message 920 may comprise an SLSS and the UE 904 may measure an RSRP of the SLSS. In some examples, the discovery message 920 may comprise a sidelink discovery (SD) message that is broadcast via a dedicated logic channel, and the UE 904 may measure an RSRP of the SD message (e.g., an SD-RSRP).

In the illustrated example, the discovery message 920 includes a PN identifier 921 that identifies the primary node with which the source AN 906 is in communication. For example, the PN identifier 921 may include an identifier associated with the source PN 908. The PN identifier 921 may include one or more of a cell identifier, a PCI and frequency, or a CGI.

At 922, the UE 904 determines that the sidelink connection with the source AN fails to satisfy a threshold (e.g., a quality threshold). For example, the UE 904 may perform an RSRP measurement based on the discovery message 920 and determine that the measured RSRP is below (or worse than) the threshold. In some examples, the thresholds may be preconfigured. In some examples, the UE 904 may receive the thresholds from a base station (e.g., the source PN 908) via, for example, a SIB or via RRC signaling.

In the illustrated example, the UE 904 receives a discovery message 924 from the target AN 910. Aspects of the discovery message 924 may be similar to the discovery message 920. The example discovery message 924 includes a PN identifier 925 that identifies the primary node with which the target AN 910 is in communication. In the illustrated example, the PN identifier 925 indicates that the target AN 910 is in communication with the source PN 908.

Although the example of FIG. 9 illustrates the UE 904 receiving the discovery message 920 prior to the determination at 922 and receiving the discovery message 924 after the determination at 922, it may be appreciated that in other examples, the UE 904 may receive the discovery message 924 before the determination at 922 or while performing the determination at 922. Additionally, it may be appreciated that the UE 904 may receive discovery messages from a set of sidelink devices, such as the source AN 906, the target AN 910, and one or more neighboring sidelink devices. For example, and with respect to the example of FIG. 7, the first UE 702 may receive discovery messages from one or more of the RSU 710 and the UEs 704, 706, 708.

At 926, the UE 904 selects a sidelink device to operate as an assistant node. The UE 904 may select the sidelink device based on the sidelink measurements performed on the received discovery messages. In some examples, the UE 904 may select the sidelink device associated with the strongest sidelink measurement. In some examples, the UE 904 may select the sidelink device by first identifying which of the sidelink devices satisfy a higher layer criteria and then selecting the sidelink device with the strongest sidelink measurement (e.g., the best RSRP) from the identified sidelink devices. For example, and with respect to the example of FIG. 7, the first UE 702 may receive discovery messages from one or more of the RSU 710 and the UEs 704, 706, 708. The first UE 702 may then identify that the third UE 706 and the fourth UE 708 satisfy the higher layer criteria, and that the third UE 706 is associated with the strongest sidelink measurement.

Returning to the example of FIG. 9, at 928, the UE 904 determines that the serving AN and the target AN are associated with a same primary node. For example, the UE 904 may compare the PN identifier 921 and the PN identifier 925 and determine that they both correspond to the same primary node (e.g., the source PN 908).

At 930, the UE 904 establishes a sidelink connection 931 with the target AN 910. The sidelink connection 931 may comprise a PC5 unicast link, such as a PC5-RRC link or a PC5-S link. In some examples, the UE 904 may use configuration information for the target AN 910 included in the discovery message 924 to establish the sidelink connection 931.

In the illustrated example, the UE 904 transmits an intra-PN change notification 932 that is received by the target AN 910. The UE 904 may transmit the intra-PN change notification 932 via the sidelink connection 931. As shown in FIG. 9, the intra-PN change notification 932 includes a source PN identifier 933. The source PN identifier 933 may comprise a same identifier as the PN identifier 925 and identify the source PN 908.

The target AN 910 and the source PN 908 perform an intra-PN change procedure 934. The intra-PN change procedure 934 enables the source PN 908 to configure the target AN 910 to operate as the assistant node for the UE 904 and the source PN 908. For example, the target AN 910 may transmit a notification to the source PN 908 indicating that the UE 904 selected the target AN 910. The source PN 908 may transmit an ACK to the target AN 910 indicating that the source PN 908 received the notification from the target AN 910 of the selection of the target AN 910.

The source PN 908 transmits an RRC reconfiguration message 936 that is received by the UE 904. In the illustrated example, the source PN 908 transmits the RRC reconfiguration message 936 to the UE 904 via the target PN 910. For example, the source PN 908 may transmit the RRC reconfiguration message 936 to the target AN 910 via the second network interface 911, and the target AN 910 may forward the RRC reconfiguration message 936 to the UE 904 via the sidelink connection 931. The example RRC reconfiguration message 936 may configure the UE 904 to use the target AN 910 as the assistant node for the UE 904 and the source PN 908. In some examples, the RRC reconfiguration message 936 may reconfigure an AN-counter (e.g., for security purposes).

As shown in FIG. 9, the UE 904 and the source PN 908 may then begin communicating control signaling 938 via the target AN 910. For example, the UE 904 may transmit control signaling 938 to the target AN 910 using the sidelink connection 931, and the target AN 920 may forward the control signaling 938 to the source PN 908 via the second network interface 911. In a similar manner, the target AN 910 may forward control signaling received from the source PN 908 to the UE 904.

It may be appreciated that in some examples, the target AN 910 may operate as a fallback user-plane. For example, the target AN 910 may act as a relay for data transmissions between the UE 904 and the source PN 908.

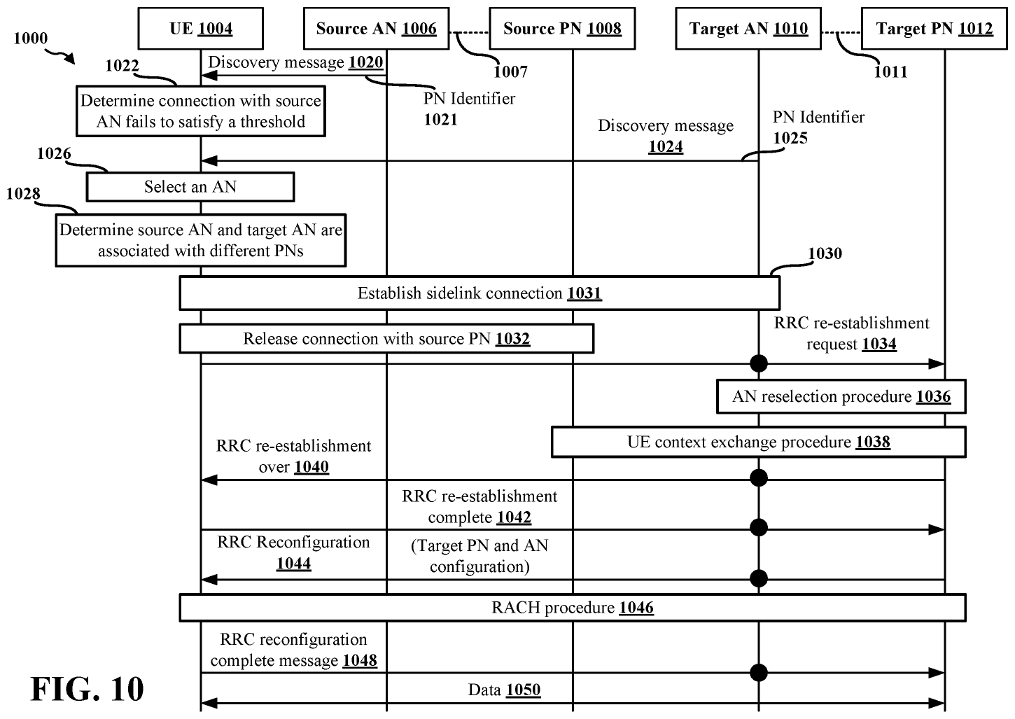

FIG. 10 illustrates an example communication flow 1000 between a UE 1004, a source AN 1006, a source PN 1008, a target AN 1010, and a target PN 1012, as presented herein. In the illustrated example, the source AN 1006 and the source PN 1008 are in communication (e.g., via a first network interface 1007) and the target AN 1010 and the source PN 1012 are in communication (e.g., via a second network interface 1011). The source PN 1008 may be in communication with a first control unit, such as the example control unit 508 of FIG. 5 and/or the control unit 608 of FIG. 6, and the target PN 1012 may be in communication with a second control unit different from that first control unit. In the illustrated example, the UE 1004 and the source AN 1006 are in communication via a sidelink connection, such as the sidelink connection 514 of FIG. 5, the PC5 link of FIG. 6, and/or the sidelink connection 905 of FIG. 9. The example UE 1004 and the source PN 1008 are in communication via an access link connection, such as the access link connection 510 of FIG. 5, the Uu link of FIG. 6, and/or the access link connection 909 of FIG. 9.

Aspects of the UE 1004 may be implemented by the UE 104 of FIG. 1, the UE 504 of FIG. 5, the UE 604 of FIG. 6, and/or the first UE 702 of FIG. 7. Aspects of the source AN 1006 and the target AN 1010 may be implemented by a sidelink device, such as the example RSU 107 of FIG. 1, the sidelink device 506 of FIG. 5, the RSU 606 of FIG. 6, and/or the UEs 704, 706, 708 and/or the RSU 710 of FIG. 7. Aspects of the source PN 1008 and the target PN 1012 may be implemented by a base station, such as the base station 102/180 of FIG. 1, the base station 502 of FIG. 5, the base station 602 of FIG. 6, and/or the first base station 730 and/or the second base station 732 of FIG. 7. Aspects of the network interfaces 1007, 1011 may be implemented by the network interface 620 of FIG. 6.

In the illustrated example, the communication flow 1000 facilitates the UE 1004 performing an inter-PN and inter-AN change. For example, and with respect to the example of FIG. 7, the first UE 702 may be in communication with the third UE 706 via a sidelink connection and may be in communication with the first base station 730 via an access link connection. The communication flow 1000 may facilitate the first UE 702 performing a mobility procedure to switch from communicating with the third UE 706 to the second UE 704 (e.g., an inter-AN change). However, since the third UE 706 and the second UE 704 are in communication with different base stations, the inter-AN change also triggers an inter-PN change in which the first UE 702 releases the access link connection with the first base station 730 and establishes an access link connection with the second base station 732.

The source AN 1006 transmits a discovery message 1020 that is received by the UE 1004 via the sidelink connection between the UE 1004 and the source AN 1006. The source AN 1006 may broadcast the discovery message 1020 periodically, aperiodically, and/or as a one-time event. The discovery message 1020 may enable the UE 1004 to perform a sidelink measurement (e.g., to measure an RSRP) of the sidelink connection between the UE 1004 and the source AN 1006. In some examples, the discovery message 1020 may comprise an SLSS and the UE 1004 may measure an RSRP of the SLSS. In some examples, the discovery message 1020 may comprise a SD message that is broadcast via a dedicated logic channel, and the UE 1004 may measure an RSRP of the SD message (e.g., an SD-RSRP).

In the illustrated example, the discovery message 1020 includes a PN identifier 1021 that identifies the primary node with which the source AN 1006 is in communication. For example, the PN identifier 1021 may include an identifier associated with the source PN 1008. The PN identifier 1021 may include one or more of a cell identifier, a PCI and frequency, or a CGI.

At 1022, the UE 1004 determines that the sidelink connection with the source AN fails to satisfy a threshold (e.g., a quality threshold). For example, the UE 1004 may perform an RSRP measurement based on the discovery message 1020 and determine that the measured RSRP is below (or worse than) the threshold. In some examples, the thresholds may be preconfigured. In some examples, the UE 1004 may receive the thresholds from a base station (e.g., the source PN 1008) via, for example, a SIB or via RRC signaling.

In the illustrated example, the UE 1004 receives a discovery message 1024 from the target AN 1010. Aspects of the discovery message 1024 may be similar to the discovery message 1020. The example discovery message 1024 includes a PN identifier 1025 that identifies the primary node with which the target AN 1010 is in communication. In the illustrated example, the PN identifier 1025 indicates that the target AN 1010 is in communication with the target PN 1012.

Although the example of FIG. 10 illustrates the UE 1004 receiving the discovery message 1020 prior to the determination at 1022 and receiving the discovery message 1024 after the determination at 1022, it may be appreciated that in other examples, the UE 1004 may receive the discovery message 1024 before the determination at 1022 or while performing the determination at 1022. Additionally, it may be appreciated that the UE 1004 may receive discovery messages from a set of sidelink devices, such as the source AN 1006, the target AN 1010, and one or more neighboring sidelink devices. For example, and with respect to the example of FIG. 7, the first UE 702 may receive discovery messages from one or more of the RSU 710 and the UEs 704, 706, 708.

At 1026, the UE 1004 selects a sidelink device to operate as an assistant node. The UE 1004 may select the sidelink device based on the sidelink measurements performed on the received discovery messages. In some examples, the UE 1004 may select the sidelink device associated with the strongest sidelink measurement. In some examples, the UE 1004 may select the sidelink device by first identifying which of the sidelink devices satisfy a higher layer criteria and then selecting the sidelink device with the strongest sidelink measurement (e.g., the best RSRP) from the identified sidelink devices. For example, and with respect to the example of FIG. 7, the first UE 702 may receive discovery messages from one or more of the RSU 710 and the UEs 704, 706, 708. The first UE 702 may then identify that the second UE 704 and the fourth UE 708 satisfy the higher layer criteria, and that the second UE 704 is associated with the strongest sidelink measurement.

Returning to the example of FIG. 10, at 1028, the UE 1004 determines that the serving AN and the target AN are associated with different primary nodes. For example, the UE 1004 may compare the PN identifier 1021 and the PN identifier 1025 and determine that the respective primary nodes are different (e.g., that the PN identifier 1021 identifies the source AN 1006 and that the PN identifier 1025 identifies the target AN 1012).

At 1030, the UE 1004 establishes a sidelink connection 1031 with the target AN 1010. The sidelink connection 1031 may comprise a PC5 unicast link, such as a PC5-RRC link or a PC5-S link. In some examples, the UE 1004 may use configuration information for the target AN 1010 included in the discovery message 1024 to establish the sidelink connection 1031.

At 1032, the UE 1004 releases the connection with the source PN. For example, the UE 1004 may release the access link connection between the UE 1004 and the source PN 1008. The UE 1004 may then attempt to establish an access link connection with the primary node indicated by the PN identifier 1025. For example, the UE 1004 may transmit an RRC re-establishment request message 1034 that is received by the target PN 1012. As shown in FIG. 10, the UE 1004 transmits the RRC re-establishment request message 1034 to the target PN 1012 via the target AN 1010. For example, the UE 1004 may transmit the RRC re-establishment request message 1034 to the target AN 1010 via the sidelink connection 1031, and the target AN 1010 may forward the RRC re-establishment request message 1034 to the target PN 1012 via the second network interface 1011.

The target PN 1012 and the target AN 1010 perform an AN reselection procedure 1036. For example, the target PN 1012 may transmit an AN addition request that is received by the target AN 1010. The target PN 1012 may transmit the AN addition request via the second network interface 1011. The target AN 1010 may transmit an AN addition ACK message that is received by the target PN 1012. The target AN 1010 may transmit the AN addition ACK message via the second network interface 1011. The AN addition ACK message may indicate that the target AN 1010 is configured to operate as the assistant node for the UE 1004 and the target PN 1012.

To reduce signaling overhead from the UE 1004, the target PN 1012 may perform a UE context exchange procedure 1038 with the source PN 1008. For example, the UE context exchange procedure 1038 may enable the target PN 1012 to obtain context information related to the UE 1004 from the source PN 1008 and forego requesting the information from the UE 1004. The UE context information provides the target PN 1012 with information regarding the PDU sessions to be relocated from the source PN 1008 to the target PN 1012. Examples of UE context information may include one or more of a Next Generation-Control (NG-C) UE associated signaling reference, a signaling transport network layer (TNL) association address at source NG-C side, UE security capabilities, Access Stratum (AS) security information, an index to RAT/frequency selection priority, a UE aggregate maximum bit rate, a PDU session resources to be setup list, RRC context information, location reporting information, and a mobility restriction list.

In the illustrated example, after performing the UE context exchange procedure 1038, the target PN 1012 transmits an RRC re-establishment over message 1040 that is received by the UE 1004. As shown in FIG. 10, the target PN 1012 transmits the RRC re-establishment over message 1040 to the UE 1004 via the target AN 1010. For example, the target AN 1010 may receive the RRC re-establishment over message 1040 from the target PN 1012 via the second network interface 1011, and the target AN 1010 may forward the RRC re-establishment over message 1040 to the UE 1004 via the sidelink connection 1031.

The UE 1004 transmits an RRC re-establishment complete message 1042 that is received by the target PN 1012. As shown in FIG. 10, the UE 1004 transmits the RRC re-establishment complete message 1042 to the target PN 1012 via the target AN 1010. For example, the UE 1004 may transmit the RRC re-establishment complete message 1042 to the target AN 1010 via the sidelink connection 1031, and the target AN 1010 may forward the RRC re-establishment complete message 1042 to the target PN 1012 via the second network interface 1011.

The target PN 1012 transmits an RRC reconfiguration message 1044 that is received by the UE 1004. In the illustrated example, the target PN 1012 transmits the RRC reconfiguration message 1044 to the UE 1004 via the target AN 1010. For example, the target PN 1012 may transmit the RRC reconfiguration message 1044 to the target AN 1010 via the second network interface 1011, and the target AN 1010 may forward the RRC reconfiguration message 1044 to the UE 1004 via the sidelink connection 1031. In the illustrated example, the RRC reconfiguration message 1044 includes configuration information for the target PN 1012 and the target AN 1010.

The UE 1004 performs a RACH procedure 1046 to establish an access link connection with the target PN 1012. The UE 1004 may use the configuration information for the target PN 1012 included in the RRC reconfiguration message 1044 to establish the access link connection.

The UE 1004 transmits an RRC reconfiguration complete message 1048 that is received by the target PN 1012. In the illustrated example, the UE 1004 transmits the RRC reconfiguration complete message 1048 to the target PN 1012 via the target AN 1010. For example, the UE 1004 may transmit the RRC reconfiguration complete message 1048 to the target AN 1010 via the sidelink connection 1031, and the target AN 810 may forward the RRC reconfiguration complete message 842 to the target PN 810 via the second network interface 811.

The UE 1004 and the target PN 1012 may then proceed to communicate data 1050 via the access link connection between the UE 1004 and the target PN 1012.

In the illustrated example, the UE 1004 transmits the RRC reconfiguration complete message 1048 to the target PN 1010, via the target AN 1010, after performing the RACH procedure 1046. However, it may be appreciated that the UE 1004 may transmit the RRC reconfiguration complete message 1048 to the target PN 1012 before performing the RACH procedure or as part of performing the RACH procedure.

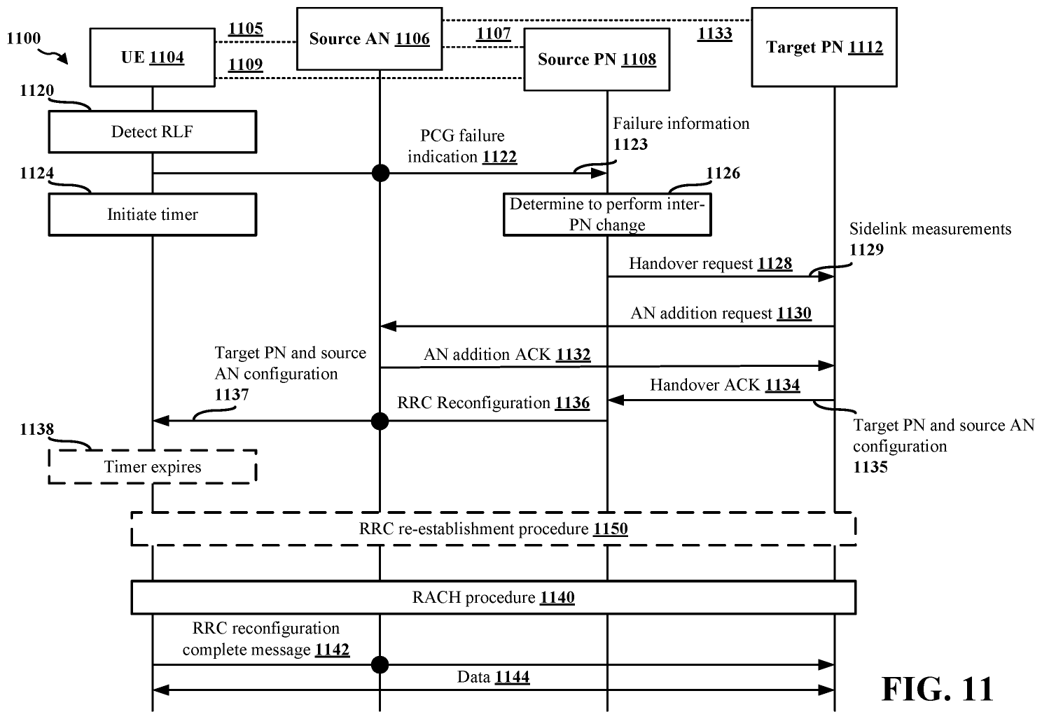

FIG. 11 illustrates an example communication flow 1100 between a UE 1104, a source AN 1106, a source PN 1108, and a target PN 1112, as presented herein. In the illustrated example, the source AN 1106 and the source PN 1108 are in communication (e.g., via a network interface 1107). In the illustrated example, the UE 1104 and the source AN 1106 are in communication via a sidelink connection 1105. The example UE 1104 and the source PN 1108 are in communication via an access link connection 1109.

Aspects of the UE 1104 may be implemented by the UE 104 of FIG. 1, the UE 504 of FIG. 5, the UE 604 of FIG. 6, and/or the first UE 702 of FIG. 7. Aspects of the source AN 1106 may be implemented by a sidelink device, such as the example RSU 107 of FIG. 1, the sidelink device 506 of FIG. 5, the RSU 606 of FIG. 6, and/or the UEs 704, 706, 708 and/or the RSU 710 of FIG. 7. Aspects of the source PN 1108 and the target PN 1112 may be implemented by a base station, such as the base station 102/180 of FIG. 1, the base station 502 of FIG. 5, the base station 602 of FIG. 6, and/or the first base station 730 and/or the second base station 732 of FIG. 7. Aspects of the sidelink connection 1105 may be implemented by the sidelink connection 514 of FIG. 5 and/or the PC5 link of FIG. 6. Aspects of the access link connection 1109 may be implemented by the access link connection 510 of FIG. 5 and/or the Uu link of FIG. 6. Aspects of the network interface 1107 may be implemented by the network interface 620 of FIG. 6.

In the illustrated example, the communication flow 1100 facilitates the UE 1104 performing a mobility procedure in response to an RLF. The UE 1104 may detect the RLF in association with the source PN 1108 and/or the source AN 1106. In aspects in which the UE 1104 detects the RLF in association with the source PN 1108, the UE 1104 may attempt to perform a fast PCG recovery to establish an access link connection with another primary node (e.g., the target PN 1112). As described below, when performing the fast PCG recovery, the UE 1104 foregoes initializing an RRC re-establishment procedure. However, if the fast PCG recovery is unsuccessful, the UE 1104 may initialize the RRC re-establishment procedure. In some examples, the fast PCG recovery may unsuccessful if the UE 1104 does not receive a response from the network before a timer expires. For example, in response to initiating the fast PCG recovery, the UE 1104 may initiate a timer and if the UE 1104 does not receive a response from the network (e.g., the source PN 1108) before the timer expires, the UE 1104 may initiate performing the RRC re-establishment procedure.

In some aspects, the UE 1104 may detect an RLF in association with the source PN 1108 and the source AN 1106. In some such examples, the UE 1104 may forego performing the fast PCG recovery and instead initiate performing the RRC re-establishment procedure.

In some aspects, the UE 1104 may detect an RLF in association with the source AN 1106. In some such examples, the UE 1104 may trigger performing an inter-AN change, as described in connection with the FIGS. 9 and/or 10.

Returning to the communication flow 1100 of FIG. 11, at 1120, the UE 1104 detects an occurrence of an RLF. In the example, the RLF is in association with the source PN 1108 and may be based on the access link connection 1109 (e.g., a PCG failure). Based on the RLF in association with the access link connection 1109, the UE 1104 may trigger a fast PCG recovery. For example, the UE 1104 transmits a PCG failure indication 1122 that is received by the source PN 1108. As shown in FIG. 11, the UE 1104 transmits the PCG failure indication 1122 via the source AN 1106. For example, the UE 1104 may transmit the PCG failure indication 1122 to the source AN 1106 via the sidelink connection 1105, and the source AN 1106 may forward the PCG failure indication 1122 to the source PN 1108 via the network interface 1107. In some examples, the UE 1104 may transmit the PCG failure indication 1122 to the source AN 1106 via a split signaling radio bearer (SRB) (e.g., an SRB1) or a PC5 bearer (when available).

In the illustrated example, the PCG failure indication 1122 includes failure information 1123. The failure information 1123 may include access link measurements and corresponding cell identifiers. For example, the failure information 1123 may include access link measurements for the source PN 1108 and any additional available access link measurements associated with neighboring base stations. Examples of access link measurements include RRM measurements associated with the source PN 1108 and any additional available base stations (e.g., the target PN 1112). Examples of cell identifiers include a PCI and a CGI. The failure information 1123 may additionally or alternatively include any available sidelink measurements for serving and neighboring sidelink devices, identifiers associated with the respective serving and neighboring sidelink devices, and PN identifiers for the primary node(s) associated with each of the respective serving and neighboring sidelink devices. Examples of sidelink measurements include RSRP measurements based on discovery messages (e.g., SD-RSRP measurements) or RSRP measurements based on SLSS received from the serving and neighboring sidelink devices, such as the source AN 1106. Examples of PN identifiers includes a cell identifier, a PCI and frequency, or a CGI. The failure information 1123 may additionally or alternatively include a failure cause, such as RLF, a handover failure, an IP check failure, and/or an RRC reconfiguration failure.

In the illustrated example, at 1124, the UE 1104 initiates a timer after transmitting the PCG failure indication 1122. The UE 1104 may use the timer to determine whether the performing of the fast PCG recovery is successful or unsuccessful.

At 1126, the source PN 1108 determines to perform an inter-PN change. For example, the source PN 1108 may use the failure information 1123 to determine that the PCG failure indication 1122 corresponds to an RLF and that there is another base station available with which the UE 1104 is capable of connecting. For example, the RRM measurements included in the failure information 1123 may indicate that there is at least one base station with which the UE 1104 may connect.

The source PN 1108 transmits a handover request 1128 that is received by the target PN 1112. As shown in FIG. 11, the handover request 1128 includes sidelink measurements 1129. For example, the handover request 1128 may include the sidelink measurements for the serving and neighboring sidelink devices included in the failure information 1123.

The target PN 1112 transmits an AN addition request 1130 that is received by the source AN 1106. The AN addition request 1130 may include information associated with the UE 1104 to configure the source AN 1106 to operate as the assistant node for the UE 1104 and the target PN 1112. The source AN 1110 transmits an AN addition ACK 1132 that is received by the target PN 1112. The AN addition ACK 1132 may indicate that the source AN 1106 is configured to operate as the assistant node for the UE 1104 and the target PN 1112.

In some examples, the AN addition request 1130 and the AN addition ACK 1132 may facilitate establishing a network interface between the source AN 1106 and the target PN 1112. For example, the AN addition request 1130 and the AN addition ACK 1132 may establish a network interface 1133 between the source AN 1106 and the target PN 1112. It may be appreciated that in other examples, a network interface between the source AN 1106 and the target PN 1112 may already exist and, thus, the exchange of the AN addition request 1130 and the AN addition ACK 1132 may not establish a new network interface between the source AN 1106 and the target PN 1112.

In the illustrated example, the target PN 1112 transmits a handover ACK message 1134 that is received by the source PN 1108. The handover ACK message 1134 includes configuration information 1135 for the target PN 1112 and the source AN 1106. For example, the configuration information 1135 may enable the UE 1104 to establish an access link connection with the target PN 1112.

The source PN 1108 transmits an RRC reconfiguration message 1136 that is received by the UE 1104. In the illustrated example, the source PN 1108 transmits the RRC reconfiguration message 1136 to the UE 1104 via the source AN 1106. For example, the source PN 1108 may transmit the RRC reconfiguration message 1136 to the source AN 1106 via the network interface 1107, and the source AN 1106 may forward the RRC reconfiguration message 1136 to the UE 1104 via the sidelink connection 1105. In the illustrated example, the RRC reconfiguration message 1136 includes configuration information 1137 for the target PN 1112 and the source AN 1106. The configuration 1137 may correspond to the configuration 1135 that the source AN 1106 receives from the target PN 1112 via the handover ACK message 1134. The configuration information may enable the UE 1104 to establish an access link connection with the target PN 1112.

In the illustrated example, the UE 1104 and the target PN 1112 perform a RACH procedure 1140 to establish an access link connection between the UE 1104 and the target PN 1112. The UE 1104 may use the configuration information 1137 for the target PN 1112 included in the RRC reconfiguration message 1136 to establish the access link connection.

The UE 1104 transmits an RRC reconfiguration complete message 1142 that is received by the target PN 1112. In the illustrated example, the UE 1104 transmits the RRC reconfiguration complete message 1142 to the target PN 1112 via the source AN 1106. For example, the UE 1104 may transmit the RRC reconfiguration complete message 1142 to the source AN 1106 via the sidelink connection 1105, and the source AN 1106 may forward the RRC reconfiguration complete message 1142 to the target PN 1110 via the network interface 1133.

The UE 1104 and the target PN 1112 may then proceed to communicate data 1144 via the access link connection between the UE 1104 and the target PN 1112.

In the illustrated example, the UE 1104 transmits the RRC reconfiguration complete message 1142 to the target PN 1112, via the source AN 1106, after performing the RACH procedure 1140. However, it may be appreciated that the UE 1104 may transmit the RRC reconfiguration complete message 1142 to the target PN 1112 before performing the RACH procedure or as part of performing the RACH procedure.

As shown in FIG. 11, the UE 1104 receives a response from the network (e.g., the RRC reconfiguration message 1136) prior to the timer expiring (e.g., at 1138). As a result, the UE 1104 may determine that the performing of the fast PCG recovery is successful and continue foregoing the performing of an RRC re-establishment procedure.

However, in examples in which the UE 1104 does not receive a response from the network (e.g., does not receive the RRC reconfiguration message 1136) prior to the timer expiring, at 1138, the UE 1104 may initiate performing an RRC re-establishment procedure 1150. In some examples, performing the RRC re-establishment procedure 1150 may include the UE 1104 transmitting an RRC re-establishment request message to the target PN 1112, receiving an RRC re-establishment over message from the target PN 1112, and transmitting an RRC re-establishment complete message to the target PN 1112. Aspects of the RRC re-establishment request message to the target PN 1112 may be similar to the RRC re-establishment request message 1034 of FIG. 10. Aspects of the RRC re-establishment over message may be similar to the RRC re-establishment over message 1040 of FIG. 10. Aspects of the RRC re-establishment complete message may be similar to the RRC re-establishment complete message 1042 of FIG. 10. In some examples, the UE 1104 and the target PN 1112 may exchange the messages of the RRC re-establishment procedure 1150 via the source AN 1106, as described in connection with the example of FIG. 10.

In the illustrated example, the UE 1104 detects the RLF (e.g., at 1120) in association with the source PN 1108 based on the access link connection 1109 between the UE 1104 and the source PN 1108. In some examples, the UE 1104 may detect an RLF in association with the source PN 1108 and the source AN 1106. In some such examples, the UE 1104 may forego performing the fast PCG recovery and instead initiate performing the RRC re-establishment procedure. For example, the UE 1104 may initiate performing the RRC re-establishment procedure 1150 after detecting the RLF (e.g., at 1120).

In some examples, the UE 1104 may detect an RLF in association with the source AN 1106 based on the sidelink connection 1105 between the UE 1104 and the source AN 1106. In some such examples, the UE 1104 may trigger performing an inter-AN change, as described in connection with the FIGS. 9 and/or 10.

Although the example of FIG. 11 illustrates that the source PN 1108 determines to perform an inter-PN change (e.g., at 1126), it may be appreciated that in some examples, the source PN 1108 may determine that a target PN is not available. In some such examples, the source PN 1108 may instruct the UE 1104 to release the source PN 1108 (e.g., to release the access link connection between the UE 1104 and the source PN 1108).

Although not shown in FIG. 11, it may be appreciated that in some examples, the target PN 1112 may select a sidelink device to operate as an assistant node for the UE 1104 and the target PN 1112. Aspects of selecting the sidelink device may be similar to 828 of FIG. 8.

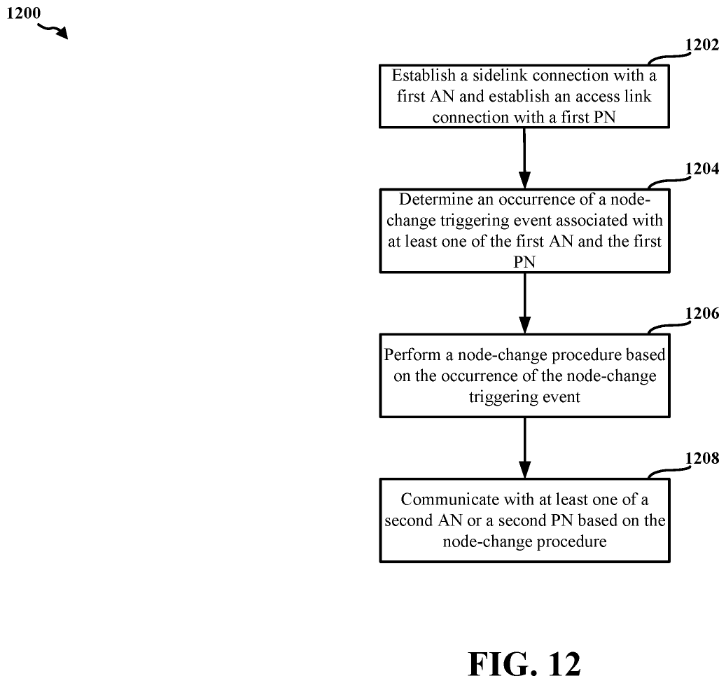

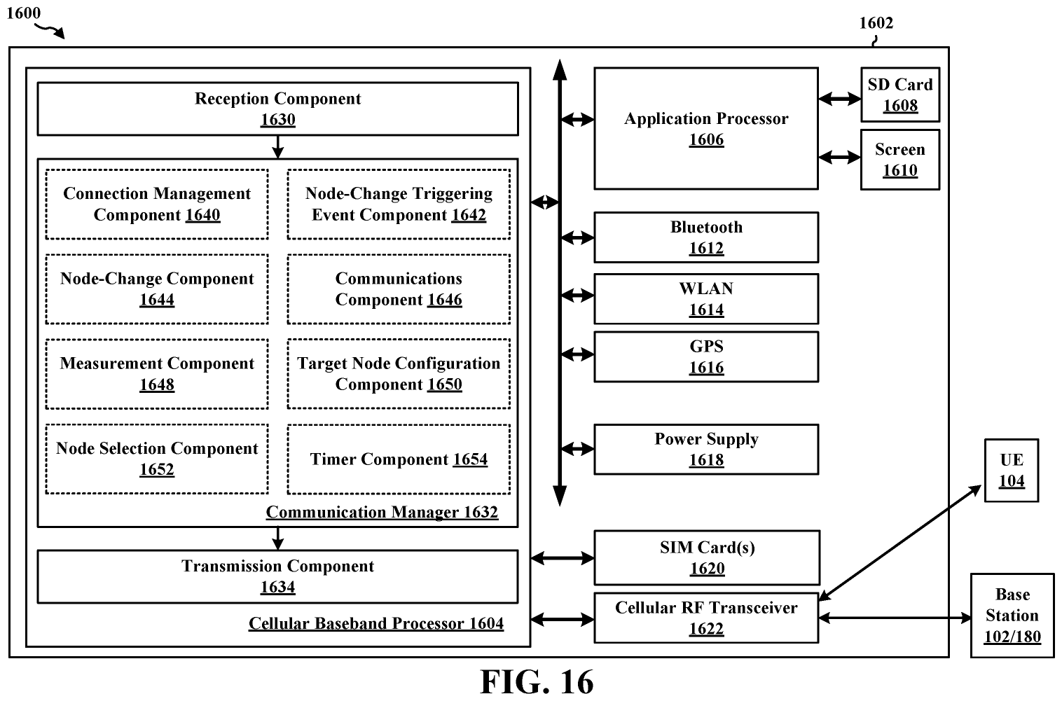

FIG. 12 is a flowchart 1200 of a method of wireless communication. The method may be performed by a UE (e.g., the UE 104, the second communication device 350, and/or an apparatus 1602 of FIG. 16). Optional aspects are illustrated with a dashed line. The method may facilitate the UE performing a mobility procedure when in communication with an assistant node and a primary node.

At 1202, the UE establishes a sidelink connection with a first AN and establishes an access link connection with a first PN, as described in connection with the sidelink connection 514 with the sidelink device 506 and the access link connection 510 with the base station 502 of FIG. 5. For example, 1202 may be performed by a connection management component 1640 of the apparatus 1602 of FIG. 16. The first AN and the first PN may communicate via a first network interface, such as the network interface 620 of FIG. 6.

In some examples, the sidelink connection may correspond to a PC5 link between the UE and the first AN. The sidelink connection with the first AN may be based on communication within a sub-6 GHz frequency range. The sidelink connection with the first AN may facilitate communicating control signaling between the UE and the first PN.

In some examples, the access link connection may correspond to a Uu link between the UE and the first PN. The access link connection with the first PN may be based on communication within a mmW frequency range. The access link connection with the first PN may facilitate communicating data between the UE and the first PN.

At 1204, the UE determines an occurrence of a node-change triggering event associated with at least one of the first AN and the first PN, as described in connection with 820 of FIG. 8, 922 of FIG. 9, 1022 of FIG. 10, and/or 1120 of FIG. 11. For example, 1204 may be performed by a node-change triggering event component 1642 of the apparatus 1602 of FIG. 16.

In some examples, the UE may determine the occurrence of the node-change triggering event based on a measurement. Aspects of a measurement-triggered occurrence of the node-change triggering event are described in connection with FIGS. 8 to 10.

In some examples, the UE may determine the occurrence of the node-change triggering event based on an RLF. Aspects of an RLF-triggered occurrence of the node-change triggering event are described in connection with FIG. 11.

At 1206, the UE performs a node-change procedure based on the occurrence of the node-change triggering event, as described in connection with the inter-PN change of FIG. 8, the intra-PN and inter-AN change of FIG. 9, the inter-PN and inter-AN change of FIG. 10, and/or the fast PCG recovery of FIG. 11. For example, 1206 may be performed by a node-change component 1644 of the apparatus 1602 of FIG. 16.

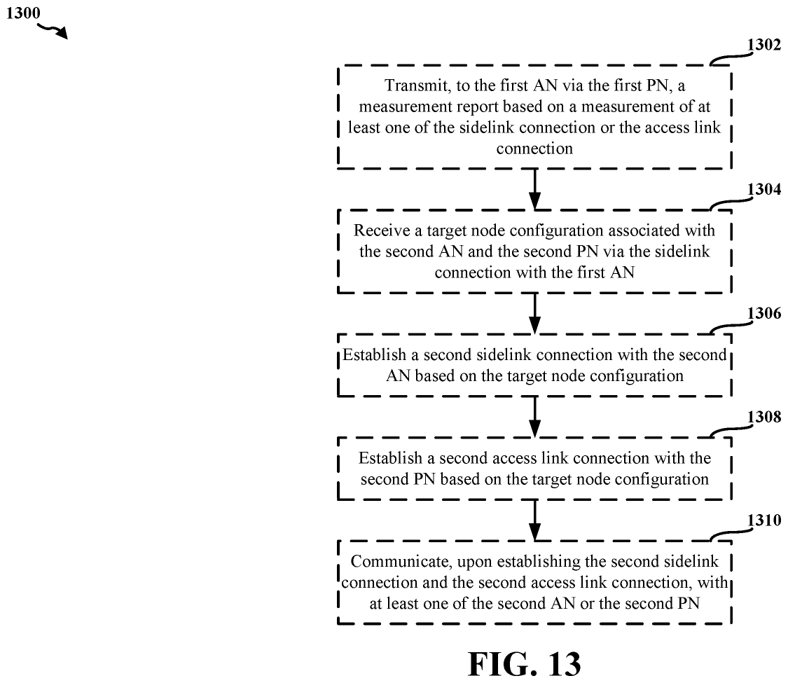

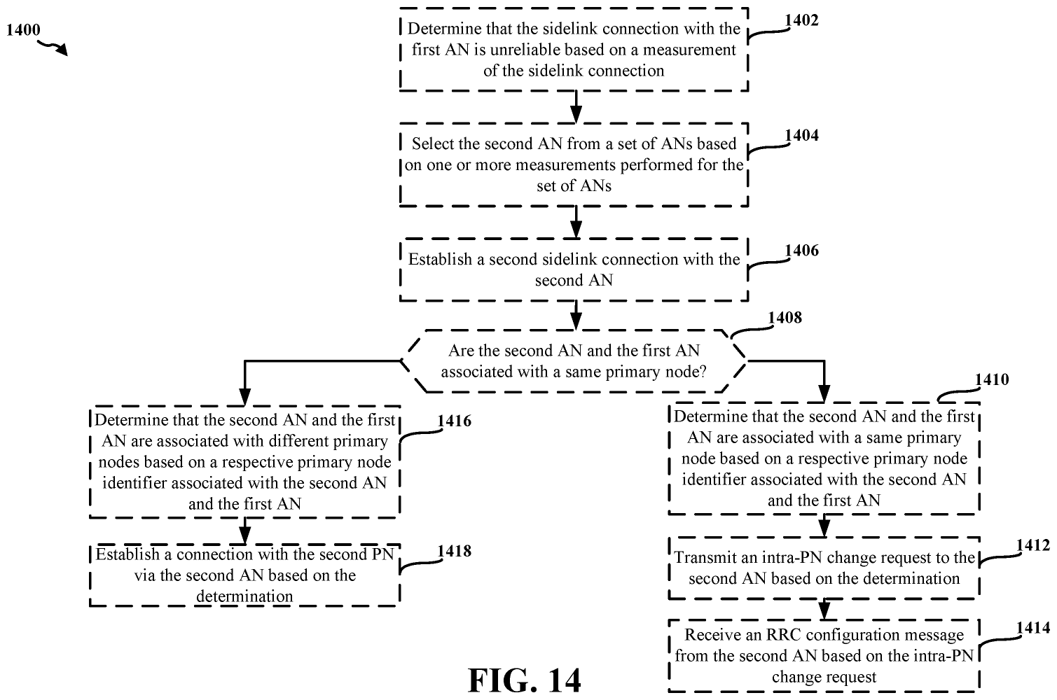

Aspects of performing a node-change procedure based on a measurement-triggered occurrence of the node-change triggering event are described in connection with FIGS. 13 and 14.

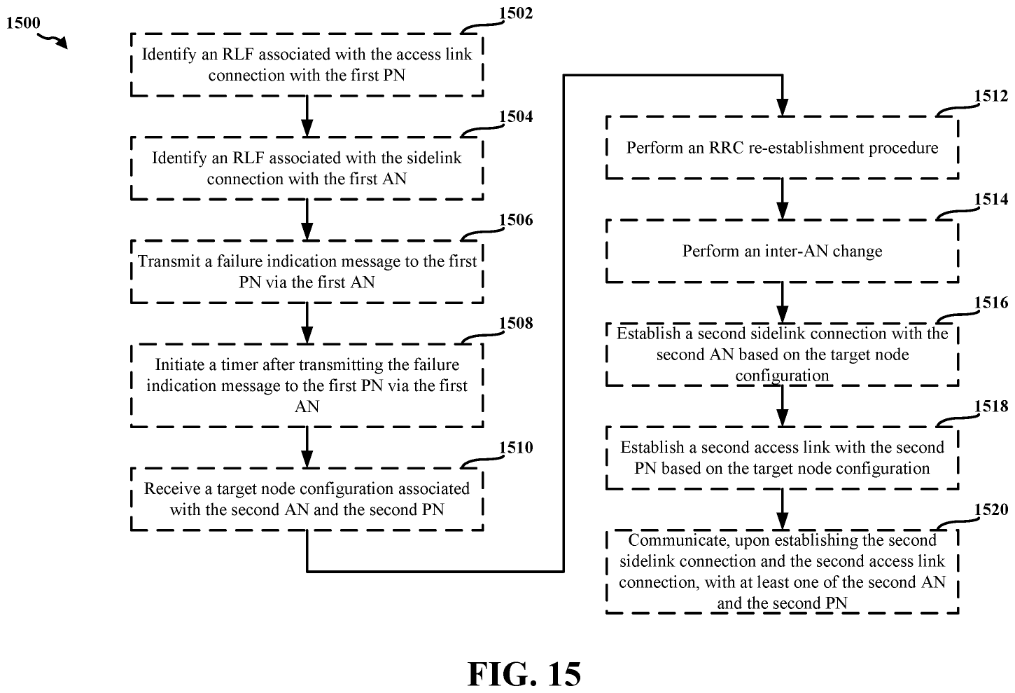

Aspects of performing a node-change procedure based on an RLF-triggered occurrence of the node-change triggering event are described in connection with FIG. 15.

At 1208, the UE communicates with at least one of a second AN or a second PN based on the node-change procedure, as described in connection with the data 844 of FIG. 8, the control signaling 938 of FIG. 9, the data 1050 of FIG. 10, and/or the data 1144 of FIG. 11. For example, 1208 may be performed by a communications component 1646 of the apparatus 1602 of FIG. 16. The second AN and the second PN may communicate via a second network interface.

In some examples, the UE may determine the occurrence of the node-change triggering event based on a measurement. FIGS. 13 and 14 illustrate aspects of performing a node-change procedure based on a measurement-triggered occurrence of the node-change triggering event.

FIG. 13 is a flowchart 1300 of a method of wireless communication. The method may be performed by a UE (e.g., the UE 104, the second communication device 350, and/or an apparatus 1602 of FIG. 16). Optional aspects are illustrated with a dashed line. The method may facilitate the UE performing an inter-PN change when in communication with an assistant node and a primary node.

At 1302, the UE may transmit, to the first AN via the first PN, a measurement report based on a measurement of at least one of the sidelink connection or the access link connection, as described in connection with measurement report 822 of FIG. 8. For example, 1302 may be performed by a measurement component 1648 of the apparatus 1602 of FIG. 16. The measurement report may comprise one or more of: RRM measurements associated with the second PN, a second PN identifier, first AN sidelink measurements, a second AN identifier, a primary node identifier associated with the second AN, and second AN sidelink measurements. In some examples, the first AN sidelink measurements and/or the second AN sidelink measurements may be based on at least one of an SLSS and a sidelink discovery message associated with the respective AN.

In some examples, the UE may perform the measurement based on a measurement gap configuration comprising an AN gap pattern and a PN gap pattern. In some examples, the measurement gap configuration may correspond to a per-UE gap in which the AN gap pattern and the PN gap pattern are associated with a same gap period. In some examples, the measurement gap configuration may correspond to a per-FR gap in which the AN gap pattern is associated with a first gap period and the PN gap pattern is associated with a second gap period that is different than the first gap period.

At 1304, the UE may receive a target node configuration associated with the second AN and the second PN via the sidelink connection with the first AN, as described in connection with the target PN and AN configuration included in the RRC reconfiguration message 836 of FIG. 8. For example, 1304 may be performed by a target node configuration component 1650 of the apparatus 1602 of FIG. 16.

At 1306, the UE may establish a second sidelink connection with the second AN based on the target node configuration, as described in connection with the sidelink connection 839 of FIG. 8. For example, 1306 may be performed by the connection management 1640 of the apparatus 1602 of FIG. 16.

At 1308, the UE may establish a second access link connection with the second PN based on the target node configuration, as described in connection with the RACH procedure 840 of FIG. 8. For example, 1308 may be performed by the connection management component 1640 of the apparatus 1602 of FIG. 16.

At 1310, the UE may communicate, upon establishing the second sidelink connection and the second access link connection, with at least one of the second AN or the second PN, as described in connection with the communication of data 844 of FIG. 8. For example, 1310 may be performed by the communications component 1646 of the apparatus 1602 of FIG. 16. In some examples, the second AN and the first AN may correspond to a same assistant node.

FIG. 14 is a flowchart 1400 of a method of wireless communication. The method may be performed by a UE (e.g., the UE 104, the second communication device 350, and/or an apparatus 1602 of FIG. 16). Optional aspects are illustrated with a dashed line. The method may facilitate the UE performing an inter-AN change when in communication with an assistant node and a primary node.

At 1402, the UE may determine that the sidelink connection with the first AN is unreliable based on a measurement of the sidelink connection, as described in connection with 922 of FIGS. 9 and/or 1022 of FIG. 10. For example, 1402 may be performed by the node-change triggering event component 1642 of the apparatus 1602 of FIG. 16. In some examples, the UE may determine that the sidelink connection with the first AN is unreliable when the measurement is below a threshold. In some examples, the thresholds may be preconfigured. In some examples, the UE may receive the thresholds from a base station, for example, via a SIB or via RRC signaling.

At 1404, the UE may select the second AN from a set of ANs based on one or more measurements performed for the set of ANs, as described in connection with 926 of FIGS. 9 and/or 1026 of FIG. 10. For example, 1404 may be performed by a node selection component 1652 of the apparatus 1602 of FIG. 16. In some examples, the measurements performed for the set of ANs may include RSRP measurements for SLSS or RSRP measurements for SD messages.

At 1406, the UE may establish a second sidelink connection with the second AN, as described in connection with the sidelink connection 931 of FIG. 9 and/or the sidelink connection 1031 of FIG. 10. For example, 1406 may be performed by the connection management component 1640 of the apparatus 1602 of FIG. 16.

At 1408, the UE may determine whether the second AN and the first AN are associated with a same priority node, as described in connection with 928 of FIGS. 9 and/or 1028 of FIG. 10. For example, 1408 may be performed by the node-change component 1644 of the apparatus 1602 of FIG. 16.

In some examples, the UE may determine, at 1410, that the second AN and the first AN are associated with a same primary node based on a respective primary node identifier associated with the second AN and the first AN, as described in connection with 928 of FIG. 9. For example, 1410 may be performed by the node-change component 1644 of the apparatus 1602 of FIG. 16. For example, the respective primary node identifiers may indicate that the second PN and the first PN correspond to the same primary node.

At 1412, the UE may transmit an intra-PN change request to the second AN based on the determination, as described in connection with intra-PN change notification 932 of FIG. 9. For example, 1412 may be performed by the communications component 1646 of the apparatus 1602 of FIG. 16.

At 1414, the UE may receive an RRC configuration message from the second AN based on the intra-PN change request, as described in connection with the RRC reconfiguration message 936 of FIG. 9. For example, 1414 may be performed by the connection management component 1640 of the apparatus 1602 of FIG. 16.

In some examples, the UE may determine, at 1416, that the second AN and the first AN are associated with different primary nodes based on a respective primary node identifier associated with the second AN and the first AN, as described in connection with 1028 of FIG. 10. For example, 1416 may be performed by the node-change component 1644 of the apparatus 1602 of FIG. 16. For example, the respective primary node identifiers may indicate that the second PN and the first PN correspond to different primary nodes.

At 1418, the UE may establish a connection with the second PN via the second AN based on the determination, as described in connection with the RACH procedure 1046 of FIG. 10. For example, 1418 may be performed by the connection management component 1640 of the apparatus 1602 of FIG. 16. The UE and the second PN may use the established connection to, for example, communicate the example data 1050 of FIG. 10.

In some examples, the UE may determine the occurrence of the node-change triggering event based on an RLF. FIG. 15 illustrates aspects of performing a node-change procedure based on an RLF-triggered occurrence of the node-change triggering event.

FIG. 15 is a flowchart 1500 of a method of wireless communication. The method may be performed by a UE (e.g., the UE 104, the second communication device 350, and/or an apparatus 1602 of FIG. 16). Optional aspects are illustrated with a dashed line. The method may facilitate the UE performing a fast PCG recovery when in communication with an assistant node and a primary node.

At 1502, the UE may identify an RLF associated with the access link connection with the first PN, as described in connection with 1120 of FIG. 11. For example, 1502 may be performed by the node-change triggering event component 1642 of the apparatus 1602 of FIG. 16.

At 1506, the UE may transmit a failure indication message to the first PN via the first AN, as described in connection with PCG failure indication 1122 of FIG. 11. For example, 1506 may be performed by the communications component 1646 of the apparatus 1602 of FIG. 16. The UE may transmit the failure indication message using a split SRB1 or PC5 bearer. In some examples, the failure indication message may comprise one or more RRM measurements associated with the second PN, a second PN identifier, first AN sidelink measurements, a second AN identifier, a primary node identifier associated with the second AN, second AN sidelink measurements, and a failure cause identifier.

At 1510, the UE may receive a target node configuration associated with the second AN and the second PN, as described in connection with the RRC reconfiguration message 1136 of FIG. 11. For example, 1510 may be performed by the target node configuration component 1650 of the apparatus 1602 of FIG. 16.

At 1516, the UE may establish a second sidelink connection with the second AN based on the target node configuration, as described in connection with the sidelink connection 839 of FIG. 8. For example, 1516 may be performed by the connection management component 1640 of the apparatus 1602 of FIG. 16.

At 1518, the UE may establish a second access link connection with the second PN based on the target node configuration, as described in connection with the RACH procedure 1140 of FIG. 11. For example, 1518 may be performed by the connection management component 1640 of the apparatus 1602 of FIG. 16.

At 1520, the UE may communicate, upon establishing the second sidelink connection and the second access link connection, with at least one of the second AN and the second PN, as described in connection with the communication of the data 1144 of FIG. 11. For example, 1520 may be performed by the communications component 1646 of the apparatus 1602 of FIG. 16.

At 1508, the UE may initiate a timer after transmitting the failure indication message to the first PN via the first AN, as described in connection with 1124 of FIG. 11. For example, 1508 may be performed by a timer component 1654 of the apparatus 1602 of FIG. 16.

In some examples, the UE may receive the target node configuration associated with the second AN and the second PN before the timer expires. In some such examples, the UE may forego performing an RRC re-establishment procedure, for example, as described in connection with the RRC re-establishment procedure 1150 of FIG. 11.

In some examples, the UE may not receive the target node configuration associated with the second AN and the second PN before the timer expires. For example, at 1512, the UE may perform a RRC re-establishment procedure when the timer expires, as described in connection with the RRC re-establishment procedure 1150 of FIG. 11. For example, 1512 may be performed by the connection management component 1640 of the apparatus 1602 of FIG. 16. In some such examples, the UE may receive the target node configuration while performing the RRC re-establishment procedure.

In some examples, the UE may identify an RLF associated with the access link connection and an RLF associated with the sidelink connection. For example, at 1504, the UE may identify an RLF associated with the sidelink connection with the first AN, as described in connection with 1120 of FIG. 11. For example, 1504 may be performed by the node-change triggering event component 1642 of the apparatus 1602 of FIG. 16. In some such examples, the UE may forego attempting to perform a fast PCG recovery and instead initiate an RRC re-establishment procedure. For example, the UE may perform, at 1512, the RRC re-establishment procedure after identifying the RLF associated with the access link connection with the first PN (e.g., at 1502) and identifying the RLF associated with the sidelink connection with the first AN (e.g., at 1504). In some such examples, the UE may receive the target node configuration while performing the RRC re-establishment procedure.

In some examples, the UE may identify (e.g., at 1504) an RLF associated with the sidelink connection with the first AN and not an RLF associated with the access link connection with the first PN. In some such examples, at 1514, the UE may perform an inter-AN change based on the identified RLF. For example, 1514 may be performed by the node-change component 1644 of the apparatus 1602 of FIG. 16. Aspects of performing the inter-AN change are described in connection with FIGS. 13 and/or 14.

FIG. 16 is a diagram 1600 illustrating an example of a hardware implementation for an apparatus 1602. The apparatus 1602 is a UE and includes a cellular baseband processor 1604 (also referred to as a modem) coupled to a cellular RF transceiver 1622 and one or more subscriber identity modules (SIM) cards 1620, an application processor 1606 coupled to a secure digital (SD) card 1608 and a screen 1610, a Bluetooth module 1612, a wireless local area network (WLAN) module 1614, a Global Positioning System (GPS) module 1616, and a power supply 1618. The cellular baseband processor 1604 communicates through the cellular RF transceiver 1622 with the UE 104 and/or base station 102/180. The cellular baseband processor 1604 may include a computer-readable medium/memory. The computer-readable medium/memory may be non-transitory. The cellular baseband processor 1604 is responsible for general processing, including the execution of software stored on the computer-readable medium/memory. The software, when executed by the cellular baseband processor 1604, causes the cellular baseband processor 1604 to perform the various functions described supra. The computer-readable medium/memory may also be used for storing data that is manipulated by the cellular baseband processor 1604 when executing software. The cellular baseband processor 1604 further includes a reception component 1630, a communication manager 1632, and a transmission component 1634. The communication manager 1632 includes the one or more illustrated components. The components within the communication manager 1632 may be stored in the computer-readable medium/memory and/or configured as hardware within the cellular baseband processor 1604. The cellular baseband processor 1604 may be a component of the second communication device 350 and may include the memory 360 and/or at least one of the TX processor 368, the RX processor 356, and the controller/processor 359. In one configuration, the apparatus 1602 may be a modem chip and include just the baseband processor 1604, and in another configuration, the apparatus 1602 may be the entire UE (e.g., see the second communication device 350 of FIG. 3) and include the additional modules of the apparatus 1602.

The communication manager 1632 includes a connection management component 1640 that is configured to establish a sidelink connection with a first AN and establish an access link connection with a first PN, for example, as described in connection with 1202 of FIG. 12. In some examples, the connection management component 1640 is configured to establish a second sidelink connection with the second AN based on the target node configuration, for example, as described in connection with 1306 of FIG. 13, and/or is configured to establish a second access link connection with the second PN based on the target node configuration, for example, as described in connection 1308 of FIG. 13. In some examples, the connection management component 1640 is configured to establish a second sidelink connection with the second AN, for example, as described in connection with 1406 of FIG. 14, is configured to receive an RRC configuration message from the second AN based on the intra-PN change request, for example, as described in connection with 1414 of FIG. 14, and/or is configured to establish a connection with the second PN via the second AN based on the determination, for example, as described in connection with 1418 of FIG. 14. In some examples, the connection management component 1640 is configured to perform a RRC re-establishment procedure, for example, as described in connection 1512 of FIG. 15, is configured to establish a second sidelink connection with the second AN based on the target node configuration, for example, as described in connection 1516 of FIG. 15, and/or is configured to establish a second access link connection with the second PN based on the target node configuration, for example, as described in connection 1518 of FIG. 15.

The communication manager 1632 also includes a node-change triggering event component 1642 that is configured to determine an occurrence of a node-change triggering event associated with at least one of the first AN and the first PN, for example, as described in connection with 1204 of FIG. 12. In some examples, the node-change triggering event component 1642 is configured to identify an RLF associated with the access link connection with the first PN, for example, as described in connection with 1502 of FIG. 15, and/or is configured to identify an RLF associated with the sidelink connection with the first AN, for example, as described in connection 1504 of FIG. 15.

The communication manager 1632 also includes a node-change component 1644 that is configured to perform a node-change procedure based on the occurrence of the node-change triggering event, for example, as described in connection with 1206 of FIG. 12. In some examples, the node-change component 1644 is configured to determine whether the second AN and the first AN are associated with a same priority node, for example, as described in connection with 1408 of FIG. 14, is configured to determine that the second AN and the first AN are associated with a same primary node based on a respective primary node identifier associated with the second AN and the first AN, for example, as described in connection with 1410 of FIG. 14, and/or is configured determine to establish a connection with the second PN via the second AN based on the determination for example, as described in connection with 1416 of FIG. 14. In some examples, the node-change component 1644 is configured to perform an inter-AN change based on the identified RLF, for example, as described in connection 1514 of FIG. 15.

The communication manager 1632 also includes a communications component 1646 that is configured to communicate with at least one of a second AN or a second PN based on the node-change procedure, for example, as described in connection with 1208 of FIG. 12. In some examples, the communications component 1646 is configured to communicate, upon establishing the second sidelink connection and the second access link connection, with at least one of the second AN or the second PN, for example, as described in connection with 1310 of FIG. 13. In some examples, the communications component 1646 is configured to transmit an intra-PN change request to the second AN based on the determination, for example, as described in connection with 1412 of FIG. 14. In some examples, the communications component 1646 is configured to transmit a failure indication message to the first PN via the first AN, for example, as described in connection 1506 of FIG. 15, and/or is configured to communicate, upon establishing the second sidelink connection and the second access link connection, with at least one of the second AN and the second PN, for example, as described in connection 1520 of FIG. 15.

The communication manager 1632 also includes a measurement component 1648 that is configured to transmit, to the first AN via the first PN, a measurement report based on a measurement of at least one of the sidelink connection or the access link connection, for example, as described in connection with 1302 of FIG. 13. In some examples, the measurement component 1648 is configured to determine that the sidelink connection with the first AN is unreliable based on a measurement of the sidelink connection, for example, as described in connection with 1402 of FIG. 14.

The communication manager 1632 also includes a target node configuration component 1650 that is configured to receive a target node configuration associated with the second AN and the second PN via the sidelink connection with the first AN, for example, as described in connection with 1304 of FIG. 13. In some examples, the target node configuration component 1650 is configured to receive a target node configuration associated with the second AN and the second PN, for example, as described in connection 1510 of FIG. 15.

The communication manager 1632 also includes a node selection component 1652 that is configured to select the second AN from a set of ANs based on one or more measurements performed for the set of ANs, for example, as described in connection with 1404 of FIG. 14.

The communication manager 1632 also includes a timer component 1654 that is configured to initiate a timer after transmitting the failure indication message to the first PN via the first AN, for example, as described in connection with 1508 of FIG. 15.

The apparatus may include additional components that perform each of the blocks of the algorithm in the aforementioned flowcharts of FIGS. 12 to 15. As such, each block in the aforementioned flowcharts of FIGS. 12 to 15 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1602, and in particular the cellular baseband processor 1604, includes means for establishing a sidelink connection with a first AN and establishing an access link connection with a first PN, the first AN and the first PN communicating via a first network interface. The example apparatus 1602 also includes means for determining an occurrence of a node-change triggering event associated with at least one of the first AN and the first PN. The example apparatus 1602 also includes means for performing a node-change procedure based on the occurrence of the node-change triggering event. The example apparatus 1602 also includes means for communicating with at least one of a second AN or a second PN based on the node-change procedure, the second AN and the second PN communicating via a second network interface. The example apparatus 1602 also includes means for transmitting, to the first AN via the first PN, a measurement report based on a measurement of at least one of the sidelink connection or the access link connection. The example apparatus 1602 also includes means for receiving a target node configuration associated with the second AN and the second PN via the sidelink connection with the first AN. The example apparatus 1602 also includes means for establishing a second sidelink connection with the second AN based on the target node configuration. The example apparatus 1602 also includes means for establishing a second access link connection with the second PN based on the target node configuration. The example apparatus 1602 also includes means for communicating, upon establishing the second sidelink connection and the second access link connection, with at least one of the second AN or the second PN. The example apparatus 1602 also includes means for determining that the sidelink connection with the first AN is unreliable based on a measurement of the sidelink connection. The example apparatus 1602 also includes means for selecting the second AN from a set of ANs based on one or more measurements performed for the set of ANs, the set of ANs included at least the second AN. The example apparatus 1602 also includes means for establishing a second sidelink connection with the second AN. The example apparatus 1602 also includes means for determining that the second AN and the first AN are associated with a same primary node based on a respective primary node identifier associated with the second AN and the first AN. The example apparatus 1602 also includes means for transmitting an intra-PN change request to the second AN based on the determination. The example apparatus 1602 also includes means for receiving an RRC configuration message from the second AN based on the intra-PN change request. The example apparatus 1602 also includes means for determining that the second AN and the first AN are associated with different primary nodes based on a respective primary node identifier associated with the second AN and the first AN. The example apparatus 1602 also includes means for establishing a connection with the second PN via the second AN based on the determination. The example apparatus 1602 also includes means for identifying an RLF associated with the access link connection with the first PN. The example apparatus 1602 also includes means for transmitting a failure indication message to the first PN via the first AN. The example apparatus 1602 also includes means for receiving a target node configuration associated with the second AN and the second PN. The example apparatus 1602 also includes means for establishing a second sidelink connection with the second AN based on the target node configuration. The example apparatus 1602 also includes means for establishing a second access link connection with the second PN based on the target node configuration. The example apparatus 1602 also includes means for communicating, upon establishing the second sidelink connection and the second access link connection, with at least one of the second AN and the second PN. The example apparatus 1602 also includes means for initiating a timer after transmitting the failure indication message to the first PN via the first AN, and where the UE receives the target node configuration before the timer expires from the first PN via the sidelink connection with the first AN. The example apparatus 1602 also includes means for initiating a timer after transmitting the failure indication message to the first PN via the first AN. The example apparatus 1602 also includes means for performing an RRC re-establishment procedure when the timer expires. The example apparatus 1602 also includes means for identifying an RLF associated with the sidelink connection with the first AN. The example apparatus 1602 also includes means for performing an RRC re-establishment procedure based on the RLF associated with the access link connection and the RLF associated with the sidelink connection. The example apparatus 1602 also includes means for identifying an RLF associated with the sidelink connection with the first AN. The example apparatus 1602 also includes means for performing an inter-AN change based on the RLF.

The aforementioned means may be one or more of the aforementioned components of the apparatus 1602 configured to perform the functions recited by the aforementioned means. As described supra, the apparatus 1602 may include the TX processor 368, the RX processor 356, and the controller/processor 359. As such, in one configuration, the aforementioned means may be the TX processor 368, the RX processor 356, and the controller/processor 359 configured to perform the functions recited by the aforementioned means.

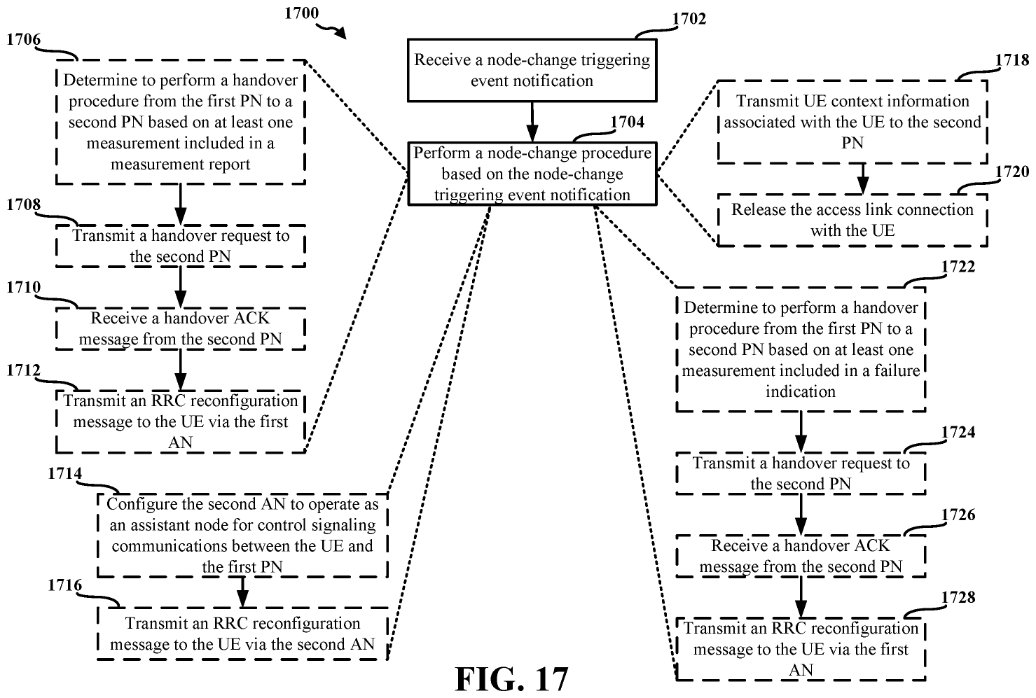

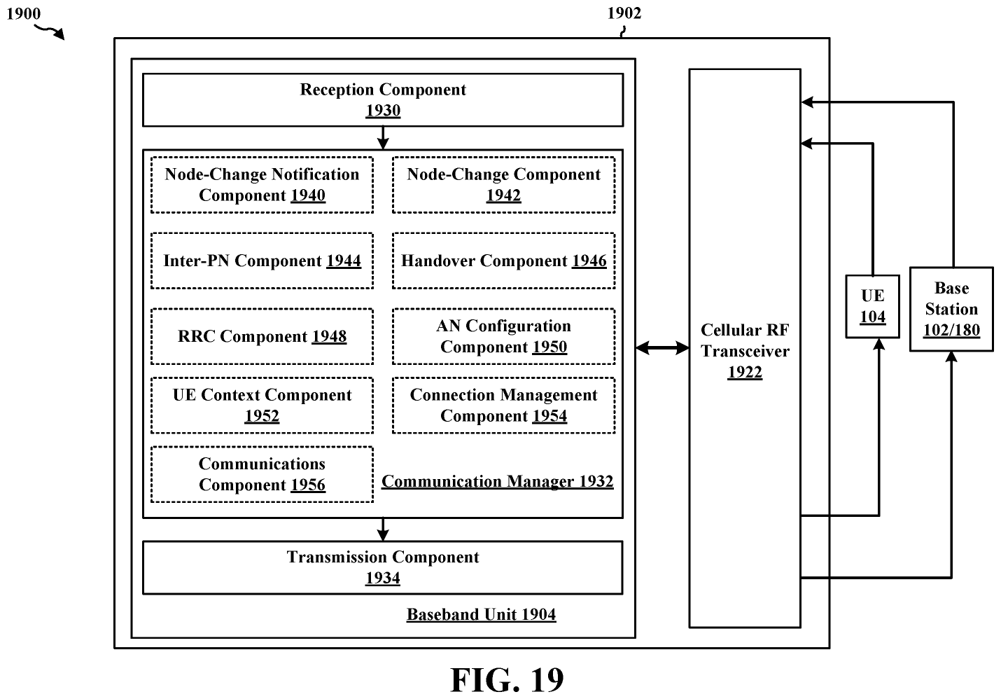

FIG. 17 is a flowchart 1700 of a method of wireless communication. The method may be performed by a source primary node, such as a base station (e.g., the base station 102/180, the first communication device 310, and/or an apparatus 1902 of FIG. 19). Optional aspects are illustrated with a dashed line. The method may facilitate improving coverage by enabling a UE to perform a mobility procedure.

In some examples, the primary node communicates data with a UE via an access link connection based on communications within a mmW frequency range, and the primary node communicates control signaling with the UE via a first AN, the primary node and the first AN communicating via a first network interface connection.

At 1702, the primary node receives a node-change triggering event notification, as described in connection with the measurement report 822 of FIG. 8, the intra-PN change procedure 934 of FIG. 9, the UE context exchange procedure 1038 of FIG. 10, and/or the PCG failure indication 1122 of FIG. 11. For example, 1702 may be performed by a node change notification component 1940 of the apparatus 1902 of FIG. 19.

At 1704, the primary node performs a node-change procedure based on the node-change triggering event notification. For example, 1704 may be performed by a node-change component 1942 of the apparatus 1902 of FIG. 19.

In some examples, the primary node may receive the node-change triggering event notification from the UE via the first AN, as described in connection with the measurement report 822 of FIG. 8. The measurement report may include one or more of RRM measurements associated with a second PN, a second PN identifier, first AN sidelink measurements, a second AN identifier, a primary node identifier associated with a second AN, and second AN sidelink measurements. In some such examples, the primary node may facilitate performing an inter-PN change based on the node-change triggering event notification. For example, at 1706, the primary node may determine to perform a handover procedure from the primary node to a second PN based on at least one measurement included in the measurement report, as described in connection with 824 of FIG. 8. For example, 1706 may be performed by an inter-PN component 1944 of the apparatus 1902 of FIG. 19.

At 1708, the primary node may transmit a handover request to the second PN, as described in connection with the handover request 826 of FIG. 8. For example, 1708 may be performed by a handover component 1946 of the apparatus 1902 of FIG. 19. The handover request may include the second AN sidelink measurements of the measurement report.

At 1710, the primary node receives a handover ACK message from the second PN, as described in connection with the handover ACK message 834 of FIG. 8. For example, 1710 may be performed by the handover component 1946 of the apparatus 1902 of FIG. 19. The handover ACK message may include a target node configuration associated with the second PN and the second AN.

At 1712, the primary node transmits an RRC reconfiguration message to the UE via the first AN, as described in connection with the RRC reconfiguration message 836 of FIG. 8. For example, 1712 may be performed by an RRC component 1948 of the apparatus 1902 of FIG. 19. The RRC reconfiguration message may include the target node configuration.

In some examples, the primary node may receive the node-change triggering event notification from a second AN in communication with the primary node via a second network interface connection, as described in connection with the intra-PN change procedure 934 of FIG. 9. The node-change triggering event notification may comprise an intra-PN change request. In some such examples, the primary node may facilitate performing an intra-PN and inter-AN change based on the node-change triggering event notification. For example, at 1714, the primary node may configure the second AN to operate as an assistant node for control signaling communications between the UE and the primary node, as described in connection with the intra-PN change procedure 934 of FIG. 9. For example, 1714 may be performed by an AN configuration component 1950 of the apparatus 1902 of FIG. 19.

At 1716, the primary node may transmit an RRC reconfiguration message to the UE via the second AN, as described in connection with the RRC reconfiguration message 936 of FIG. 9. For example, 1716 may be performed by the RRC component 1948 of the apparatus 1902 of FIG. 19.

In some examples, the primary node may receive the node-change triggering event notification from a second PN, as described in connection with the UE context exchange procedure 1038 of FIG. 10. The node-change triggering event notification may comprise a UE context exchange request. In some such examples, the primary node may facilitate performing an inter-PN and inter-AN change based on the node-change triggering event notification. For example, at 1718, the primary node may transmit UE context information associated with the UE to the second PN, as described in connection with the UE context exchange procedure 1038 of FIG. 10. For example, 1718 may be performed by a UE context component 1952 of the apparatus 1902 of FIG. 19.

At 1720, the primary node may release the access link connection with the UE, as described in connection with 1032 of FIG. 10. For example, 1720 may be performed by a connection management component 1954 of the apparatus 1902 of FIG. 19.

In some examples, the primary node may receive the node-change triggering event notification from the UE via the first AN, as described in connection with the PCG failure indication 1122 of FIG. 11. The PCG failure indication may include one or more of RRM measurements associated with a second PN, a second PN identifier, first AN sidelink measurements, a second AN identifier, a primary node identifier associated with the second AN, second AN sidelink measurements, and a failure cause identifier. In some such examples, the primary node may facilitate performing a fast PCG recovery based on the node-change triggering event notification. For example, at 1722, the primary node may determine to perform a handover procedure from the primary node to a second PN based on at least one measurement included in the failure indication, as described in connection with 1126 of FIG. 11. For example, 1722 may be performed by the inter-PN component 1944 of the apparatus 1902 of FIG. 19.

At 1724, the primary node may transmit a handover request to the second PN, as described in connection with the handover request 1128 of FIG. 11. For example, 1724 may be performed by the handover component 1946 of the apparatus 1902 of FIG. 19. The handover request may include the second AN sidelink measurements of the failure indication.

At 1726, the primary node receives a handover ACK message from the second PN, as described in connection with the handover ACK message 1134 of FIG. 11. For example, 1726 may be performed by the handover component 1946 of the apparatus 1902 of FIG. 19. The handover ACK message may include a target node configuration 1135 associated with the second PN and the second AN.

At 1728, the primary node transmits an RRC reconfiguration message to the UE via the first AN, as described in connection with the RRC reconfiguration message 1136 of FIG. 11. For example, 1728 may be performed by the RRC component 1948 of the apparatus 1902 of FIG. 19. The RRC reconfiguration message may include the target node configuration 1137.

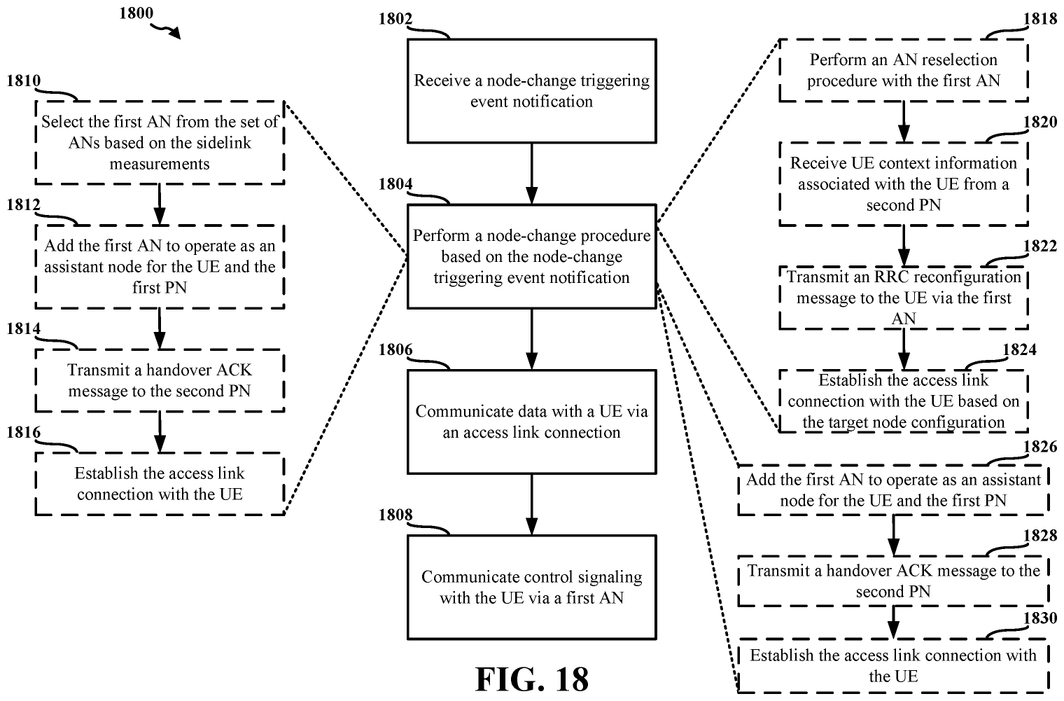

FIG. 18 is a flowchart 1800 of a method of wireless communication. The method may be performed by a target primary node, such as a base station (e.g., the base station 102/180, the first communication device 310, and/or an apparatus 1902 of FIG. 19). Optional aspects are illustrated with a dashed line. The method may facilitate improving coverage by enabling a UE to perform a mobility procedure.

At 1802, the primary node receives a node-change triggering event notification, as described in connection with the handover request 826 of FIG. 8, the RRC re-establishment request message 1034 of FIG. 10, and/or the handover request 1128 of FIG. 11. For example, 1802 may be performed by the node change notification component 1940 of the apparatus 1902 of FIG. 19.

At 1804, the primary node performs a node-change procedure based on the node-change triggering event notification. For example, 1804 may be performed by a node-change component 1942 of the apparatus 1902 of FIG. 19.

At 1806, the primary node communicates data with a UE via an access link connection based on communications within a mmW frequency range, as described in connection with the data 844 of FIG. 8, the data 1050 of FIG. 10, and/or the data 1144 of FIG. 11. For example, 1806 may be performed by a communications component 1956 of the apparatus 1902 of FIG. 19.

At 1808, the primary node communicates control signaling with the UE via a first AN, as described in connection with the control signaling 938 of FIG. 9. For example, 1808 may be performed by the communications component 1956 of the apparatus 1902 of FIG. 19. The primary node and the first AN may communicate via a first network interface connection

In some examples, the primary node may receive the node-change triggering event notification from a second PN. For example, the node-change triggering event notification may comprise a handover request including sidelink measurements associated with a set of ANs including at least the first AN, as described in connection with the handover request 826 of FIG. 8. For example, at 1810, the primary node may select the first AN from the set of ANs based on the sidelink measurements, as described in connection with 828 of FIG. 8. For example, 1810 may be performed by the AN configuration component 1950 of the apparatus 1902 of FIG. 19.

At 1812, the primary node may add the first AN to operate as an assistant node for the UE and the primary node via the first network interface connection, as described in connection with the AN addition request 830 of FIG. 8. For example, 1812 may be performed by the AN configuration component 1950 of the apparatus 1902 of FIG. 19.

At 1814, the primary node may transmit a handover ACK message to the second PN, as described in connection with the handover ACK message 834 of FIG. 8. For example, 1814 may be performed by the handover component 1946 of the apparatus 1902 of FIG. 19. The handover ACK message may include a target node configuration associated with the primary node and the first AN.

At 1816, the primary node may establish the access link connection with the UE, as described in connection with the RACH procedure 840 of FIG. 8. For example, 1816 may be performed by the connection management component 1954 of the apparatus 1902 of FIG. 19.

In some examples, the primary node may receive the node-change triggering event notification from the UE via the first AN, as described in connection with the RRC re-establishment request message 1034 of FIG. 10. In some such examples, the primary node may facilitate performing an inter-PN and inter-AN change based on the node-change triggering event notification. For example, at 1818, the primary node may perform an AN reselection procedure with the first AN, as described in connection with the AN reselection procedure 1036 of FIG. 10. For example, 1818 may be performed by the AN configuration component 1950 of the apparatus 1902 of FIG. 19.

At 1820, the primary node may receive UE context information associated with the UE from a second PN, as described in connection with the UE context exchange procedure 1038 of FIG. 10. For example, 1820 may be performed by the UE context component 1952 of the apparatus 1902 of FIG. 19. The second PN may communicate data with the UE via a second access link connection.

At 1822, the primary node may transmit an RRC reconfiguration message to the UE via the first AN, as described in connection with the RRC reconfiguration message 1044 of FIG. 10. For example, 1822 may be performed by the RRC component 1948 of the apparatus 1902 of FIG. 19. The RRC reconfiguration message may include a target node configuration associated with the first and the primary node.

At 1824, the primary node may establish the access link connection with the UE based on the target node configuration, as described in connection with the RACH procedure 1046 of FIG. 10. For example, 1824 may be performed by the connection management component 1954 of the apparatus 1902 of FIG. 19.

In some examples, the primary node may receive the node-change triggering event notification from a second PN. For example, the node-change triggering event notification may include a handover request including sidelink measurements associated with a set of ANs including at least the first AN, as described in connection with the handover request 1128 of FIG. 11. In some such examples, the primary node may facilitate performing a fast PCG recovery based on the node-change triggering event notification. For example, at 1826, the primary node may add the first AN to operate as an assistant node for the UE and the primary node via the first network interface connection, as described in connection with AN addition request 1130 of FIG. 11. For example, 1826 may be performed by the AN configuration component 1950 of the apparatus 1902 of FIG. 19.

At 1828, the primary node may transmit a handover ACK message to the second PN, as described in connection with the handover ACK message 1134 of FIG. 11. For example, 1828 may be performed by the handover component 1946 of the apparatus 1902 of FIG. 19. The handover ACK message may include a target node configuration 1135 associated with the primary node and the first AN.

At 1830, the primary node may establish the access link connection with the UE, as described in connection with the RACH procedure 1140 of FIG. 11. For example, 1830 may be performed by the connection management component 1954 of the apparatus 1902 of FIG. 19.

FIG. 19 is a diagram 1900 illustrating an example of a hardware implementation for an apparatus 1902. The apparatus 1902 is a base station and includes a baseband unit 1904. The baseband unit 1904 may communicate through a cellular RF transceiver 1922 with the UE 104. The baseband unit 1904 may include a computer-readable medium/memory. The baseband unit 1904 is responsible for general processing, including the execution of software stored on the computer-readable medium/memory. The software, when executed by the baseband unit 1904, causes the baseband unit 1904 to perform the various functions described supra. The computer-readable medium/memory may also be used for storing data that is manipulated by the baseband unit 1904 when executing software. The baseband unit 1904 further includes a reception component 1930, a communication manager 1932, and a transmission component 1934. The communication manager 1932 includes the one or more illustrated components. The components within the communication manager 1932 may be stored in the computer-readable medium/memory and/or configured as hardware within the baseband unit 1904. The baseband unit 1904 may be a component of the first communication device 310 and may include the memory 376 and/or at least one of the TX processor 316, the RX processor 370, and the controller/processor 375.

The communication manager 1932 includes a node-change notification component 1940 that is configured to receive a node-change triggering event notification, for example, as described in connection with 1702 of FIG. 17. In some examples, the node-change notification component 1940 is configured to receive a node-change triggering event notification, for example, as described in connection with 1802 of FIG. 18.

The communication manager 1932 also includes a node-change component 1942 that is configured to perform a node-change procedure based on the node-change triggering event notification, for example, as described in connection with 1704 of FIG. 17. In some examples, the node-change component 1942 is configured to perform a node-change procedure based on the node-change triggering event notification, for example, as described in connection with 1804 of FIG. 18.

The communication manager 1932 also includes an inter-PN component 1944 that is configured to determine to perform a handover procedure from the first PN to the second PN based on at least one measurement included in the measurement report, for example, as described in connection with 1706 of FIG. 17, and/or is configured to determine to perform a handover procedure from the first PN to the second PN based on at least one measurement included in the failure indication, for example, as described in connection with 1722 of FIG. 17.

The communication manager 1932 also includes a handover component 1946 that is configured to transmit a handover request to the second PN, the handover request including the second AN sidelink measurements of the measurement report, for example, as described in connection with 1708 of FIG. 17, is configured to receive a handover acknowledgement message from the second PN, for example, as described in connection with 1710 of FIG. 17, is configured to transmit a handover request to the second PN, for example, as described in connection with 1724 of FIG. 17, and/or is configured to receive a handover acknowledgement message from the second PN, for example, as described in connection with 1726 of FIG. 17. In some examples, the handover component 1946 is configured to transmit a handover acknowledgement message to the second PN, for example, as described in connection with 1814 of FIG. 18, and/or is configured to transmit a handover acknowledgement message to the second PN, for example, as described in connection with 1828 of FIG. 18.

The communication manager 1932 also includes an RRC component 1948 that is configured to transmit an RRC reconfiguration message to the UE via the first AN for example, as described in connection with 1712 of FIG. 17, is configured to transmit an RRC reconfiguration message to the UE via the second AN, for example, as described in connection with 1716 of FIG. 17, and/or is configured to transmit an RRC reconfiguration message to the UE via the first AN, for example, as described in connection with 1728 of FIG. 17. In some examples, the RRC component 1948 is configured to transmit an RRC reconfiguration message to the UE via the first AN, for example, as described in connection with 1822 of FIG. 18.

The communication manager 1932 also includes an AN configuration component 1950 that is configured to configure the second AN to operate as an assistant node for control signaling communications between the UE and the first PN, for example, as described in connection with 1714 of FIG. 17. In some examples, the AN configuration component 1950 is configured to select the first AN from the set of ANs based on the sidelink measurements, for example, as described in connection with 1810 of FIG. 18, is configured to add the first AN to operate as an assistant node for the UE and the first PN via the first network interface connection, for example, as described in connection with 1812 of FIG. 18, is configured to perform an AN reselection procedure with the first AN, for example, as described in connection with 1818 of FIG. 18, and/or is configured to add the first AN to operate as an assistant node for the UE and the first PN via the first network interface connection, for example, as described in connection with 1826 of FIG. 18.

The communication manager 1932 also includes a UE context component 1952 that is configured to transmit UE context information associated with the UE to the second PN, for example, as described in connection with 1718 of FIG. 17. In some examples, the UE context component 1952 is configured to receive UE context information associated with the UE from a second PN, for example, as described in connection with 1820 of FIG. 18.

The communication manager 1932 also includes a connection management component 1954 that is configured to release the access link connection with the UE, for example, as described in connection with 1720 of FIG. 17. In some examples, the connection management component 1954 is configured to establish the access link connection with the UE, for example, as described in connection with 1816 of FIG. 18, is configured to establish the access link connection with the UE based on the target node configuration, for example, as described in connection with 1824 of FIG. 18, and/or is configured to establish the access link connection with the UE based on the target node configuration, for example, as described in connection with 1830 of FIG. 18.

The communication manager 1932 also includes a communications component 1956 that is configured to communicate data with a UE via an access link connection based on communications within a mmW frequency range, for example, as described in connection with 1806 of FIG. 18, and/or is configured to control signaling with the UE via a first AN, the first PN and the first AN communicating via a first network interface connection, for example, as described in connection with 1808 of FIG. 18.

The apparatus may include additional components that perform each of the blocks of the algorithm in the aforementioned flowcharts of FIGS. 17 and/or 18. As such, each block in the aforementioned flowcharts of FIGS. 17 and/or 18 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1902, and in particular the baseband unit 1904, includes means for receiving a node-change triggering event notification. The example apparatus 1902 also includes means for performing a node-change procedure based on the node-change triggering event notification. The example apparatus 1902 also includes means for determining to perform a handover procedure from the first PN to the second PN based on at least one measurement included in the measurement report. The example apparatus 1902 also includes means for transmitting a handover request to the second PN, the handover request including the second AN sidelink measurements of the measurement report. The example apparatus 1902 also includes means for receiving a handover acknowledgement message from the second PN, the handover acknowledgement message comprising a target node configuration associated with the second PN and the second AN. The example apparatus 1902 also includes means for transmitting a radio resource control (RRC) reconfiguration message to the UE via the first AN, the RRC reconfiguration message including the target node configuration. The example apparatus 1902 also includes means for configuring the second AN to operate as an assistant node for control signaling communications between the UE and the first PN. The example apparatus 1902 also includes means for transmitting a radio resource control (RRC) reconfiguration message to the UE via the second AN. The example apparatus 1902 also includes means for transmitting UE context information associated with the UE to the second PN. The example apparatus 1902 also includes means for releasing the access link connection with the UE. The example apparatus 1902 also includes means for determining to perform a handover procedure from the first PN to the second PN based on at least one measurement included in the failure indication. The example apparatus 1902 also includes means for transmitting a handover request to the second PN, the handover request including the second AN sidelink measurements of the failure indication. The example apparatus 1902 also includes means for receiving a handover acknowledgement message from the second PN, the handover acknowledgement message comprising a target node configuration associated with the second PN and the second AN. The example apparatus 1902 also includes means for transmitting a radio resource control (RRC) reconfiguration message to the UE via the first AN, the RRC reconfiguration message including the target node configuration. The example apparatus 1902 also includes means for receiving a node-change triggering event notification. The example apparatus 1902 also includes means for performing a node-change procedure based on the node-change triggering event notification. The example apparatus 1902 also includes means for communicating data with a user equipment (UE) via an access link connection based on communications within a millimeter wave (mmW) frequency range. The example apparatus 1902 also includes means for communicating control signaling with the UE via a first assistant node (AN), the first PN and the first AN communicating via a first network interface connection. The example apparatus 1902 also includes means for selecting the first AN from the set of ANs based on the sidelink measurements. The example apparatus 1902 also includes means for adding the first AN to operate as an assistant node for the UE and the first PN via the first network interface connection. The example apparatus 1902 also includes means for transmitting a handover acknowledgement message to the second PN, the handover acknowledgement message comprising a target node configuration associated with the first PN and the first AN. The example apparatus 1902 also includes means for establishing the access link connection with the UE based on the target node configuration. The example apparatus 1902 also includes means for performing an AN reselection procedure with the first AN. The example apparatus 1902 also includes means for receiving UE context information associated with the UE from a second PN, the second PN communicating data with the UE via a second access link connection. The example apparatus 1902 also includes means for transmitting an RRC reconfiguration message to the UE via the first AN, the RRC reconfiguration message including a target node configuration associated with the first AN and the first PN. The example apparatus 1902 also includes means for establishing the access link connection with the UE based on the target node configuration. The example apparatus 1902 also includes means for adding the first AN to operate as an assistant node for the UE and the first PN via the first network interface connection. The example apparatus 1902 also includes means for transmitting a handover acknowledgement message to the second PN, the handover acknowledgement message comprising a target node configuration associated with the first PN and the first AN. The example apparatus 1902 also includes means for establishing the access link connection with the UE based on the target node configuration.

The aforementioned means may be one or more of the aforementioned components of the apparatus 1902 configured to perform the functions recited by the aforementioned means. As described supra, the apparatus 1902 may include the TX processor 316, the RX processor 370, and the controller/processor 375. As such, in one configuration, the aforementioned means may be the TX processor 316, the RX processor 370, and the controller/processor 375 configured to perform the functions recited by the aforementioned means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.

Aspect 1 is a method of wireless communication of a user equipment (UE), comprising: establishing a sidelink connection with a first assistant node (AN) and establishing an access link connection with a first primary node (PN), the first AN and the first PN communicating via a first network interface; determining an occurrence of a node-change triggering event associated with at least one of the first AN and the first PN; performing a node-change procedure based on the occurrence of the node-change triggering event; and communicating with at least one of a second AN or a second PN based on the node-change procedure, the second AN and the second PN communicating via a second network interface.

Aspect 2 is the method of aspect 1, further including that the sidelink connection with the first AN is based on communication within a sub-6 GHz frequency range, and the access link connection with the first PN is based on communication within a millimeter wave (mmW) frequency range.

Aspect 3 is the method of any of aspect 1 or aspect 2, further including that the sidelink connection with the first AN facilitates communicating control signaling between the UE and the first PN, and the access link connection with the first PN facilitates communicating data between the UE and the first PN.

Aspect 4 is the method of any of aspects 1 to 3, further including that determining of the occurrence of the node-change triggering event is measurement-triggered.

Aspect 5 is the method of any of aspects 1 to 4, further including: transmitting, to the first AN via the first PN, a measurement report based on a measurement of at least one of the sidelink connection or the access link connection, where the measurement report comprises one or more of: radio resource management (RRM) measurements associated with the second PN, a second PN identifier, first AN sidelink measurements, a second AN identifier, a primary node identifier associated with the second AN, and second AN sidelink measurements.

Aspect 6 is the method of any of aspects 1 to 5, further including that the first AN sidelink measurements are based on at least one of a sidelink synchronization signal (SLSS) associated with the first AN and a sidelink discovery message associated with the first AN.

Aspect 7 is the method of any of aspects 1 to 6, further including: receiving a target node configuration associated with the second AN and the second PN via the sidelink connection with the first AN; establishing a second sidelink connection with the second AN based on the target node configuration; establishing a second access link connection with the second PN based on the target node configuration; and communicating, upon establishing the second sidelink connection and the second access link connection, with at least one of the second AN or the second PN.

Aspect 8 is the method of any of aspects 1 to 7, further including that the second AN and the first AN correspond to a same assistant node.

Aspect 9 is the method of any of aspects 1 to 8, further including: determining that the sidelink connection with the first AN is unreliable based on a measurement of the sidelink connection; selecting the second AN from a set of ANs based on one or more measurements performed for the set of ANs, the set of ANs included at least the second AN; and establishing a second sidelink connection with the second AN.

Aspect 10 is the method of any of aspects 1 to 9, further including: determining that the second AN and the first AN are associated with a same primary node based on a respective primary node identifier associated with the second AN and the first AN; transmitting an intra-PN change request to the second AN based on the determination; and receiving a radio resource control (RRC) configuration message from the second AN based on the intra-PN change request.

Aspect 11 is the method of any of aspects 1 to 10, further including that the respective primary node identifiers indicate that the second PN and the first PN correspond to a same primary node.

Aspect 12 is the method of any of aspects 1 to 11, further including: determining that the second AN and the first AN are associated with different primary nodes based on a respective primary node identifier associated with the second AN and the first AN; and establishing a connection with the second PN via the second AN based on the determination.

Aspect 13 is the method of any of aspects 1 to 12, further including that the UE performs a measurement of at least one of the sidelink connection or the access link connection based on a measurement gap configuration comprising an AN gap pattern and a PN gap pattern, and wherein the AN gap pattern and the PN gap pattern are associated with a same gap period.

Aspect 14 is the method of any of aspects 1 to 12, further including that the UE performs a measurement of at least one of the sidelink connection or the access link connection based on a measurement gap configuration comprising an AN gap pattern and a PN gap pattern, the AN gap pattern associated with a first gap period and the PN gap pattern associated with a second gap period that is different than the first gap period.

Aspect 15 is the method of any of aspects 1 to 14, further including that determining the occurrence of the node-change triggering event is radio link failure-triggered.

Aspect 16 is the method of any of aspects 1 to 15, further including: identifying a radio link failure (RLF) associated with the access link connection with the first PN; transmitting a failure indication message to the first PN via the first AN; receiving a target node configuration associated with the second AN and the second PN; establishing a second sidelink connection with the second AN based on the target node configuration; establishing a second access link connection with the second PN based on the target node configuration; and communicating, upon establishing the second sidelink connection and the second access link connection, with at least one of the second AN and the second PN.

Aspect 17 is the method of any of aspects 1 to 16, further including that the failure indication message comprises one or more of: radio resource management (RRM) measurements associated with the second PN, a second PN identifier, first AN sidelink measurements, a second AN identifier, a primary node identifier associated with the second AN, second AN sidelink measurements, and a failure cause identifier.

Aspect 18 is the method of any of aspects 1 to 17, further including: initiating a timer after transmitting the failure indication message to the first PN via the first AN, and where the UE receives the target node configuration before the timer expires from the first PN via the sidelink connection with the first AN.

Aspect 19 is the method of any of aspects 1 to 18, further including: initiating a timer after transmitting the failure indication message to the first PN via the first AN; and performing a radio resource control (RRC) re-establishment procedure when the timer expires, where the UE receives the target node configuration while performing the RRC re-establishment procedure.

Aspect 20 is the method of any of aspects 1 to 19, further including: identifying an RLF associated with the sidelink connection with the first AN; and performing a radio resource control (RRC) re-establishment procedure based on the RLF associated with the access link connection and the RLF associated with the sidelink connection, where the UE receives the target node configuration while performing the RRC re-establishment procedure.

Aspect 21 is the method of any of aspects 1 to 20, further including: identifying a radio link failure (RLF) associated with the sidelink connection with the first AN; and performing an inter-AN change based on the RLF.

Aspect 22 is an apparatus for wireless communication including at least one processor coupled to a memory and configured to implement a method as in any of aspects 1 to 21.

Aspect 23 is an apparatus for wireless communication including means for implementing a method as in any of aspects 1 to 21.

Aspect 24 is a non-transitory computer-readable storage medium storing computer executable code, where the code, when executed, causes a processor to implement a method as in any of aspects 1 to 21.

Aspect 25 is a method of wireless communication of a first primary node (PN), comprising: receiving a node-change triggering event notification; and performing a node-change procedure based on the node-change triggering event notification.

Aspect 26 is the method of aspect 25, further including that the first PN communicates data with a user equipment (UE) via an access link connection based on communications within a millimeter wave (mmW) frequency range, and the first PN communicates control signaling with the UE via a first assistant node (AN), the first PN and the first AN communicating via a first network interface connection.

Aspect 27 is the method of any of aspect 25 or aspect 26, further including that the first PN receives the node-change triggering event notification from the UE via the first AN, the node-change triggering event comprising a measurement report including one or more of: radio resource management (RRM) measurements associated with a second PN, a second PN identifier, first AN sidelink measurements, a second AN identifier, a primary node identifier associated with a second AN, and second AN sidelink measurements.

Aspect 28 is the method of any of aspects 25 to 27, further including that performing the node-change procedure based on the node-change triggering event notification comprises: determining to perform a handover procedure from the first PN to the second PN based on at least one measurement included in the measurement report; transmitting a handover request to the second PN, the handover request including the second AN sidelink measurements of the measurement report; receiving a handover acknowledgement message from the second PN, the handover acknowledgement message comprising a target node configuration associated with the second PN and the second AN; and transmitting a radio resource control (RRC) reconfiguration message to the UE via the first AN, the RRC reconfiguration message including the target node configuration.

Aspect 29 is the method of any of aspects 25 to 28, further including that the first PN receives the node-change triggering event notification from a second AN, the node-change triggering event notification comprising an intra-PN change request, the first PN and the second AN communicating via a second network interface connection.

Aspect 30 is the method of any of aspects 25 to 29, further including that performing the node-change procedure based on the node-change triggering event notification comprises: configuring the second AN to operate as an assistant node for control signaling communications between the UE and the first PN; and transmitting a radio resource control (RRC) reconfiguration message to the UE via the second AN.

Aspect 31 is the method of any of aspects 25 to 30, further including that the first PN receives the node-change triggering event notification from a second PN, the node-change triggering event notification comprising a UE context exchange request.

Aspect 32 is the method of any of aspects 25 to 31, further including that performing the node-change procedure based on the node-change triggering notification comprises: transmitting UE context information associated with the UE to the second PN; and releasing the access link connection with the UE.

Aspect 33 is the method of any of aspects 25 to 32, further including that the first PN receives the node-change triggering event notification from the UE via the first AN, the node-change triggering event comprising a failure indication including one or more of: radio resource management (RRM) measurements associated with a second PN, a second PN identifier, first AN sidelink measurements, a second AN identifier, a primary node identifier associated with the second AN, second AN sidelink measurements, and a failure cause identifier.

Aspect 34 is the method of any of aspects 25 to 33, further including that performing the node-change procedure based on the node-change triggering event notification comprises: determining to perform a handover procedure from the first PN to the second PN based on at least one measurement included in the failure indication; transmitting a handover request to the second PN, the handover request including the second AN sidelink measurements of the failure indication; receiving a handover acknowledgement message from the second PN, the handover acknowledgement message comprising a target node configuration associated with the second PN and the second AN; and transmitting a radio resource control (RRC) reconfiguration message to the UE via the first AN, the RRC reconfiguration message including the target node configuration.

Aspect 35 is an apparatus for wireless communication including at least one processor coupled to a memory and configured to implement a method as in any of aspects 25 to 34.

Aspect 36 is an apparatus for wireless communication including means for implementing a method as in any of aspects 25 to 34.

Aspect 37 is a non-transitory computer-readable storage medium storing computer executable code, where the code, when executed, causes a processor to implement a method as in any of aspects 25 to 34.

Aspect 38 is a method of wireless communication of a first primary node (PN), comprising: receiving a node-change triggering event notification; performing a node-change procedure based on the node-change triggering event notification; communicating data with a user equipment (UE) via an access link connection based on communications within a millimeter wave (mmW) frequency range; and communicating control signaling with the UE via a first assistant node (AN), the first PN and the first AN communicating via a first network interface connection.

Aspect 39 is the method of aspect 38, further including that the first PN receives the node-change triggering event notification from a second PN, the node-change triggering event comprising a handover request including sidelink measurements associated with a set of ANs including at least the first AN.

Aspect 40 is the method of any of aspect 38 or aspect 39, further including that performing the node-change procedure based on the node-change triggering event notification comprises: selecting the first AN from the set of ANs based on the sidelink measurements; adding the first AN to operate as an assistant node for the UE and the first PN via the first network interface connection; transmitting a handover acknowledgement message to the second PN, the handover acknowledgement message comprising a target node configuration associated with the first PN and the first AN; and establishing the access link connection with the UE based on the target node configuration.

Aspect 41 is the method of any of aspects 38 to 40, further including that the first PN receives the node-change triggering event notification from the UE via the first AN, the node-change triggering event notification comprising a radio resource control (RRC) re-establishment request.

Aspect 42 is the method of any of aspects 38 to 41, further including that performing the node-change procedure based on the node-change triggering notification comprises: performing an AN reselection procedure with the first AN; receiving UE context information associated with the UE from a second PN, the second PN communicating data with the UE via a second access link connection; transmitting an RRC reconfiguration message to the UE via the first AN, the RRC reconfiguration message including a target node configuration associated with the first AN and the first PN; and establishing the access link connection with the UE based on the target node configuration.

Aspect 43 is the method of any of aspects 38 to 42, further including that the first PN receives the node-change triggering event notification from a second PN, the node-change triggering event comprising a handover request including sidelink measurements associated with a set of ANs including at least the first AN.

Aspect 44 is the method of any of aspects 38 to 43, further including that performing the node-change procedure based on the node-change triggering event notification comprises: adding the first AN to operate as an assistant node for the UE and the first PN via the first network interface connection; transmitting a handover acknowledgement message to the second PN, the handover acknowledgement message comprising a target node configuration associated with the first PN and the first AN; and establishing the access link connection with the UE based on the target node configuration.

Aspect 45 is an apparatus for wireless communication including at least one processor coupled to a memory and configured to implement a method as in any of aspects 38 to 44.

Aspect 46 is an apparatus for wireless communication including means for implementing a method as in any of aspects 38 to 44.

Aspect 47 is a non-transitory computer-readable storage medium storing computer executable code, where the code, when executed, causes a processor to implement a method as in any of aspects 38 to 44.

What is claimed is:

1. A method of wireless communication of a user equipment (UE), comprising:
establishing a sidelink connection with a first assistant node (AN) and establishing an access link connection with a first primary node (PN), the first AN and the first PN communicating via a first network interface;
determining an occurrence of a node-change triggering event associated with at least one of the first AN and the first PN;
performing a node-change procedure based on the occurrence of the node-change triggering event; and
communicating with at least one of a second AN or a second PN based on the node-change procedure, the second AN and the second PN communicating via a second network interface.

2. The method of claim 1, wherein
the sidelink connection with the first AN is based on communication within a sub-6 GHz frequency range, and
the access link connection with the first PN is based on communication within a millimeter wave (mmW) frequency range.

3. The method of claim 1, wherein
the sidelink connection with the first AN facilitates communicating control signaling between the UE and the first PN, and
the access link connection with the first PN facilitates communicating data between the UE and the first PN.

4. The method of claim 1, wherein determining of the occurrence of the node-change triggering event is measurement-triggered.

5. The method of claim 4, further comprising:
transmitting, to the first AN via the first PN, a measurement report based on a measurement of at least one of the sidelink connection or the access link connection,
wherein the measurement report comprises one or more of: radio resource management (RRM) measurements associated with the second PN, a second PN identifier, first AN sidelink measurements, a second AN identifier, a primary node identifier associated with the second AN, and second AN sidelink measurements.

6. The method of claim 5, wherein the first AN sidelink measurements are based on at least one of a sidelink synchronization signal (SLSS) associated with the first AN and a sidelink discovery message associated with the first AN.

7. The method of claim 4, further comprising:
receiving a target node configuration associated with the second AN and the second PN via the sidelink connection with the first AN;
establishing a second sidelink connection with the second AN based on the target node configuration;
establishing a second access link connection with the second PN based on the target node configuration; and
communicating, upon establishing the second sidelink connection and the second access link connection, with at least one of the second AN or the second PN.

8. The method of claim 7, wherein the second AN and the first AN correspond to a same assistant node.

9. The method of claim 4, further comprising:
determining that the sidelink connection with the first AN is unreliable based on a measurement of the sidelink connection;
selecting the second AN from a set of ANs based on one or more measurements performed for the set of ANs, the set of ANs included at least the second AN; and
establishing a second sidelink connection with the second AN.

10. The method of claim 9, further comprising:
determining that the second AN and the first AN are associated with a same primary node based on a respective primary node identifier associated with the second AN and the first AN;
transmitting an intra-PN change request to the second AN based on the determination; and
receiving a radio resource control (RRC) configuration message from the second AN based on the intra-PN change request.

11. The method of claim 10, wherein the respective primary node identifiers indicate that the second PN and the first PN correspond to a same primary node.

12. The method of claim 9, further comprising:
determining that the second AN and the first AN are associated with different primary nodes based on a respective primary node identifier associated with the second AN and the first AN; and
establishing a connection with the second PN via the second AN based on the determination.

13. The method of claim 4, wherein the UE performs a measurement of at least one of the sidelink connection or the access link connection based on a measurement gap configuration comprising an AN gap pattern and a PN gap pattern, and wherein the AN gap pattern and the PN gap pattern are associated with a same gap period.

14. The method of claim 4, wherein the UE performs a measurement of at least one of the sidelink connection or the access link connection based on a measurement gap configuration comprising an AN gap pattern and a PN gap pattern, the AN gap pattern associated with a first gap period and the PN gap pattern associated with a second gap period that is different than the first gap period.

15. The method of claim 1, wherein determining the occurrence of the node-change triggering event is radio link failure-triggered.

16. The method of claim 15, further comprising:
identifying a radio link failure (RLF) associated with the access link connection with the first PN;
transmitting a failure indication message to the first PN via the first AN;
receiving a target node configuration associated with the second AN and the second PN;
establishing a second sidelink connection with the second AN based on the target node configuration;
establishing a second access link connection with the second PN based on the target node configuration; and
communicating, upon establishing the second sidelink connection and the second access link connection, with at least one of the second AN and the second PN.

17. The method of claim 16, wherein the failure indication message comprises one or more of: radio resource management (RRM) measurements associated with the second PN, a second PN identifier, first AN sidelink measurements, a second AN identifier, a primary node identifier associated with the second AN, second AN sidelink measurements, and a failure cause identifier.

18. The method of claim 16, further comprising:
initiating a timer after transmitting the failure indication message to the first PN via the first AN, and
wherein the UE receives the target node configuration before the timer expires from the first PN via the sidelink connection with the first AN.

19. The method of claim 16, further comprising:
initiating a timer after transmitting the failure indication message to the first PN via the first AN; and
performing a radio resource control (RRC) re-establishment procedure when the timer expires,
wherein the UE receives the target node configuration while performing the RRC re-establishment procedure.

20. The method of claim 16, further comprising:
identifying an RLF associated with the sidelink connection with the first AN; and
performing a radio resource control (RRC) re-establishment procedure based on the RLF associated with the access link connection and the RLF associated with the sidelink connection,
wherein the UE receives the target node configuration while performing the RRC re-establishment procedure.

21. The method of claim 15, further comprising:
identifying a radio link failure (RLF) associated with the sidelink connection with the first AN; and
performing an inter-AN change based on the RLF.

22. An apparatus for wireless communication of a user equipment (UE), comprising:
a memory; and
at least one process coupled to the memory and configured to:
establish a sidelink connection with a first assistant node (AN) and establishing an access link connection with a first primary node (PN), the first AN and the first PN communicating via a first network interface;
determine an occurrence of a node-change triggering event associated with at least one of the first AN and the first PN;
perform a node-change procedure based on the occurrence of the node-change triggering event; and
communicate with at least one of a second AN or a second PN based on the node-change procedure, the second AN and the second PN communicating via a second network interface.

23. A method of wireless communication of a first primary node (PN), comprising:
receiving a node-change triggering event notification;
performing a node-change procedure based on the node-change triggering event notification;
communicating data with a user equipment (UE) via an access link connection based on communications within a millimeter wave (mmW) frequency range; and
communicating control signaling with the UE via a first assistant node (AN), the first PN and the first AN communicating via a first network interface connection.

24. The method of claim 23, wherein the first PN receives the node-change triggering event notification from a second PN, the node-change triggering event comprising a handover request including sidelink measurements associated with a set of ANs including at least the first AN.

25. The method of claim 24, wherein performing the node-change procedure based on the node-change triggering event notification comprises:
selecting the first AN from the set of ANs based on the sidelink measurements;
adding the first AN to operate as an assistant node for the UE and the first PN via the first network interface connection;
transmitting a handover acknowledgement message to the second PN, the handover acknowledgement message comprising a target node configuration associated with the first PN and the first AN; and
establishing the access link connection with the UE based on the target node configuration.

26. The method of claim 23, wherein the first PN receives the node-change triggering event notification from the UE via the first AN, the node-change triggering event notification comprising a radio resource control (RRC) re-establishment request.

27. The method of claim 26, wherein performing the node-change procedure based on the node-change triggering notification comprises:
performing an AN reselection procedure with the first AN;
receiving UE context information associated with the UE from a second PN, the second PN communicating data with the UE via a second access link connection;
transmitting an RRC reconfiguration message to the UE via the first AN, the RRC reconfiguration message including a target node configuration associated with the first AN and the first PN; and
establishing the access link connection with the UE based on the target node configuration.

28. The method of claim 23, wherein the first PN receives the node-change triggering event notification from a second PN, the node-change triggering event comprising a handover request including sidelink measurements associated with a set of ANs including at least the first AN.

29. The method of claim 28, wherein performing the node-change procedure based on the node-change triggering event notification comprises:
adding the first AN to operate as an assistant node for the UE and the first PN via the first network interface connection;
transmitting a handover acknowledgement message to the second PN, the handover acknowledgement message comprising a target node configuration associated with the first PN and the first AN; and
establishing the access link connection with the UE based on the target node configuration.

30. An apparatus for wireless communication of a first primary node (PN), comprising:
a memory; and
at least one process coupled to the memory and configured to:
receive a node-change triggering event notification;
perform a node-change procedure based on the node-change triggering event notification;
communicate data with a user equipment (UE) via an access link connection based on communications within a millimeter wave (mmW) frequency range; and
communicate control signaling with the UE via a first assistant node (AN), the first PN and the first AN communicating via a first network interface connection.
